(19) United States
(12) Patent Application Publication
(10) Pub. No.: US 2015/0145336 A1
(43) Pub. Date: May 28, 2015

(54) MODULAR POWER CONVERSION SYSTEM AND METHOD

(71) Applicants: Antoine Marc Joseph Richard Paquin, Navan (CA); Raymond Kenneth Orr, Kanata (CA)

(72) Inventors: Antoine Marc Joseph Richard Paquin, Navan (CA); Raymond Kenneth Orr, Kanata (CA)

(73) Assignee: SOLANTRO SEMICONDUCTOR CORP., Ottawa (CA)

(21) Appl. No.: 14/092,346

(22) Filed: Nov. 27, 2013

(51) Int. Cl. H02M 1/10; H02M 7/04; H02M 7/44; H02M 1/42

(52) U.S. Cl. CPC H02M 1/10; H02M 1/4216; H02M 7/04; H02M 7/44
USPC 307/52

(57) ABSTRACT

A method for converting electrical power includes providing a modular power converter having a mode control module and a plurality of autonomously operating power conversion modules operatively connected to a first power bus; selecting, by the mode control module, individual modes of operation for the plurality of power conversion modules to meet a power conversion requirement; receiving electrical power of a first power type from the first power bus by at least one of the power conversion modules; and converting the received electrical power into electrical power of a second power type by the at least one power conversion module.

### BACKGROUND

1. Technical Field

The embodiments and methods described herein generally relate to power conversion and power converters, and more particularly to improvements in their reliability, efficiency, and scalability.

2. Description of the Related Art

Power converters convert one form of electrical power to another. For example, a Direct Current (DC) to DC power converter could convert a variable DC voltage produced by, for example, a photovoltaic panel into a constant DC voltage to charge a battery. Similarly, a DC to Alternating Current (AC) inverter could convert the variable DC voltage of a photovoltaic panel into a constant AC voltage to supply power to an electrical grid. DC to AC inverters can supply both active power and reactive power and can have single phase or multi-phase outputs. AC to DC converters convert AC power into DC power. For example, an AC to DC converter might convert AC power from the electrical grid into DC power to charge a battery.

Power converters can be unidirectional or bidirectional. A unidirectional power converter has defined input and output terminals and power flows only into the input terminals and out of the output terminals. A bidirectional power converter does not have defined input and output terminals. Power can flow either into or out of a set of terminals. For example, a bidirectional AC to DC converter might convert AC power from the electrical grid into DC power to charge a battery during one part of the day and might then convert DC power from the battery into AC power to supply the grid during another part of the day.

Volts-Amperes-reactive (VAr) compensators are power converters that provide purely reactive power. VAr compensators are used to correct the power factor in the presence of large reactive loads. For example, if there is a large inductive load, a VAr compensator could supply reactive power to correct the power factor closer to unity. If there is a large capacitive load, the VAr compensator could consume reactive power to correct the power factor closer to unity. VAr compensators are also used to regulate the voltage and frequency of the transmission grid.

Power converters such as, for example, DC to DC converters, DC to AC inverters, bidirectional converters, or VAr compensators could be of a monolithic design. They could only contain a single instance of each major power converter component. They could be designed with a fixed maximum power capacity and not be designed to be scalable or upgradeable.

Module approaches to power converter design consist of modularizing portions of the converters functionality. For example, a three phase switching mode DC to AC converter could use three, single phase, DC to AC switching modules with a central controller generating the switch signals. An AC to AC power converter for a wind generator could consist of one module for the input portion of the converter to convert a variable AC voltage to a constant DC voltage and a second module for the output portion of the converter to convert DC to AC for an electrical grid, the two modules being connected by an intermediate power bus. In known modular power converters, the modules are typically not autonomous and do not perform the complete power conversion function of the power converter.

### SUMMARY

In view of the foregoing, an embodiment herein provides a method for converting electrical power, the method comprising providing a modular power converter comprising a mode control module and a plurality of autonomously operating power conversion modules operatively connected to a first power bus; selecting, by the mode control module, individual modes of operation for the plurality of power conversion modules to meet a power conversion requirement; receiving electrical power of a first power type from the first power bus by at least one of the power conversion modules; and converting the received electrical power into electrical power of a second power type by the at least one power conversion module. The plurality of power conversion modules comprise may substantially equal volts-amperes-reactive conversion capacities, and wherein the selecting of individual modes of operation comprises selecting the power conversion modules to operate in either a standby mode or one of an inductive or a capacitive mode so that reactive power is either absorbed or supplied to the first power bus. The power conversion modules operating in one of the inductive or capacitive mode all convert substantially the same volts-amperes-reactive (VAr) amounts.

The method may further comprise supplying the power of the second power type to a second power bus that is operatively connected to each of the plurality of autonomously operating power conversion modules. The selecting of individual modes of operation may comprise selecting the power conversion modules to operate in different power modes selected based on a substantially maximum power efficiency. The individual modes of operation may comprise any of an efficient power mode, a variable power mode, and a standby mode. The selecting of individual modes of operation may comprise selecting one of the power conversion modules to operate in a variable power mode and selecting all other power conversion modules to operate in either an efficient power mode or a standby mode during power conversion. The selecting of individual modes of operation may comprise selecting the plurality of power conversion modules to all operate in an equal power mode when the power conversion requirement is greater than a maximum efficient power of the modular power converter.

The selecting of individual modes of operation may comprise selecting at least one of the power conversion modules to operate in a power maximization mode and selecting all other power conversion modules to operate in an efficient power mode or standby mode. wherein in the power maximization mode, the method further comprises the at least one of the power conversion modules operating a maximum power point tracking process that maximizes a power production of a photovoltaic panel array operatively connected to the second power bus. The selecting of individual modes of operation may comprise selecting at least one of the power conversion modules to operate in a power maximization mode and all other power conversion modules to operate in equal power maximum power point tracking mode when the power conversion requirement is greater than a maximum efficient power of the modular power converter.

The selecting of individual modes of operation may comprise selecting at least one of the power conversion modules to operate in a reactive power mode. The selecting of individual modes of operation may comprise selecting a number of power conversion modules to operate in any of the reactive power mode and a complex power mode to meet a reactive power requirement up to a remaining power conversion capacity of the modular power converter. The power conversion modules selected for the complex power mode produces reactive power to meet a reactive power requirement up to a remaining reactive power of the power conversion module and all remaining power conversion modules operate in a standby mode or produce only real power. The method may further comprise supplying the power of the second type on the second power bus after conversion from the power of the first type on the first power bus or supplying the power of the first type on the first power bus after conversion from the power of the second type on the second power bus.

The first power bus may comprise a multiphase bus and the steps of selecting of individual modes of operation and converting the received power into the electrical power of the second type by the at least one power conversion module may comprise providing differing amounts of electrical power to each phase of the multiphase bus to maintain root mean square (RMS) voltage values of the different phases substantially equal.

Another embodiment provides a modular power converter system comprising a first power bus; a plurality of autonomously functioning power conversion modules operatively connected to the first power bus; and a mode control module that selects power conversion modes for the plurality of autonomously functioning power conversion modules, wherein the plurality of autonomously functioning power conversion modules convert electrical power on the first power bus having power of a first power type into power of a second power type depending on power conversion requirements. The system may further comprise a second power bus operatively connected to each of the plurality of autonomously functioning power conversion modules, wherein the plurality of autonomously functioning power conversion modules function to convert power from the first power bus comprising a first power type into power comprising a second power type for output onto the second power bus. The system may further comprise a second power bus operatively connected to each of the plurality of autonomously functioning power conversion modules, wherein the plurality of autonomously functioning power conversion modules: convert power from the first power bus comprising the first power type into power comprising the second power type for output onto the second power bus, and convert power from the second power bus comprising a second power type into power comprising the first power type for output onto the first power bus.

The system may further comprise a switching module to operably engage the modular power converter to a first external electrical power source; and a plurality of electrical connections operatively connected to the second power bus to operably connect to a second external electrical power source, wherein the modular power converter bidirectionally converts power between the first power bus and the second power bus, and wherein the switching module engages or disengages the first external electrical power source from the modular power converter. The first external electrical power source may comprise an AC grid, and wherein the second external electrical power source comprises a DC storage device. The switching module may disconnect the AC grid from the modular power converter during a grid power outage. The system may further comprise a power shelf to which the plurality of autonomously functioning power conversion modules and the mode control module are removably mounted thereto.

The system may further comprise a communication bus; a plurality of first socket connections in the power shelf that provide electrical connection of the plurality of autonomously functioning power conversion modules to the first power bus; and a plurality of second socket connections that operatively connect the plurality of autonomously functioning power conversion modules and the mode control module to the communication bus. The power shelf may comprise a rack comprising at least one slot that receives the mode control module. The autonomously functioning power conversion modules and the mode control module may be removably attached and detached to the power shelf without powering down the modular power converter system.

Another embodiment provides a modular power converter comprising a communication bus; a first DC power bus; an AC power bus; a second DC power bus; a plurality of autonomously functioning power conversion modules of a first type operatively connected to the communication bus, each operatively connected to the first DC power bus, and each operatively connected to the second DC power bus; a plurality of autonomously functioning power conversion modules of a second type operatively connected to the communication bus, each operatively connected to the first DC power bus, and each operatively connected to the AC power bus; an electrical connection that operatively connects the first DC power bus to an external power source; and a mode control module operatively connected to the communication bus, wherein the mode control module selects power conversion modes for the plurality of autonomously functioning power conversion modules, wherein the modular power converter performs multiple power conversion functions depending on load and power conversion requirements. The modular power converter may further comprise an electrical connection that operatively connects the second DC power bus to a power generator.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 is a block diagram of a bidirectional modular power converter (MPC) according to an embodiment herein;

FIG. 2A is a block diagram of a unidirectional MPC according to an embodiment herein;

FIG. 2B is a block diagram of a unidirectional MPC with a redundant control bus and mode control module;

FIG. 3A is a block diagram of a MPC which functions as a VAr compensator according to an embodiment herein;

FIG. 3B is a flowchart of an efficient VAr compensation method according to an embodiment herein;

FIG. 4A is a block diagram of a MPC which functions as an AC battery storage system according to an embodiment herein;

FIG. 4B is a block diagram of an MPC forming part of an uninterruptible power supply (UPS) according to an embodiment herein;

FIG. 5 is a block diagram of an example MPC forming part of a battery backed photovoltaic power system according to an embodiment herein;

FIG. 6A is a drawing of an example of a power shelf racking system according to an embodiment herein;

FIG. 6B is a drawing of an MPC designed as a power shelf according to an embodiment herein;

FIG. 7A is a drawing of an example slot connector arrangement for a single slot of a power shelf according to an embodiment herein;

FIG. 7B is a drawing of an example module connector arrangement for the DC to DC power conversion modules (PCMs) of FIG. 5 according to an embodiment herein;

FIG. 7C is a drawing of an example module connector arrangement for the DC to AC PCMs of FIG. 5 according to an embodiment herein;

FIG. 7D is a drawing of an example module connector arrangement for the islanding switch module of FIG. 5 according to an embodiment herein;

FIG. 7E is a drawing of an example module connector arrangement for the MPC mode control module of FIG. 5 according to an embodiment herein;

FIG. 8 is a drawing of one embodiment of a power cabinet according to an embodiment herein;

FIG. 9A is a flowchart of an efficiency optimization method according to an embodiment herein;

FIG. 9B is a flowchart of an equal power method according to an embodiment herein;

FIG. 10A is a flowchart of a power maximization method according to an embodiment herein;

FIG. 10B is a flowchart of an equal power maximum power point tracking (MPPT) method according to an embodiment herein;

FIG. 10C is a flowchart illustrating a reactive power method according to an embodiment herein;

FIG. 10D is a flowchart illustrating a complex power method according to an embodiment herein;

FIG. 10E is a flow diagram of a self-test method according to an embodiment herein;

FIG. 11 is a block diagram of one embodiment of a MPC mode control module according to an embodiment herein; and

FIG. 12 is a block diagram of an example PCM according to an embodiment herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

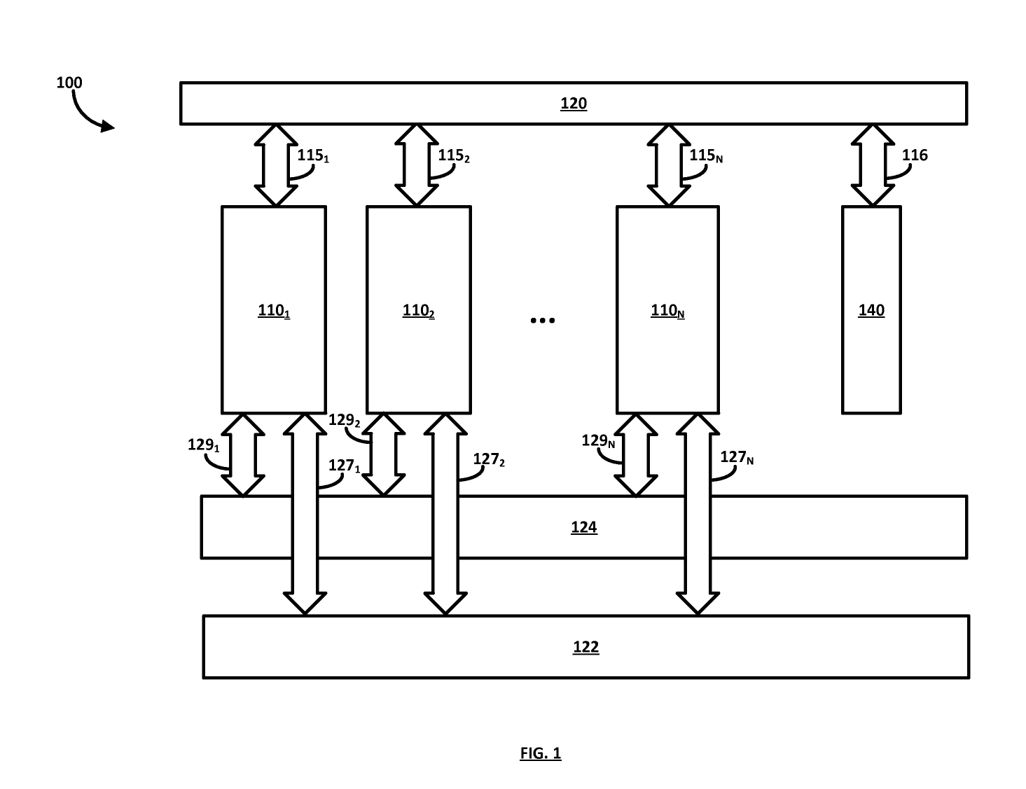

The embodiments herein provide a modular power converter operating a plurality of power conversion modules. Referring now to the drawings, and more particularly to FIGS. 1 through 12, where similar reference characters denote corresponding features consistently throughout the figures, there are shown preferred embodiments.

As used herein:

“Power type” means electrical power that can be either DC power, single phase AC power, or three phase AC power, wherein in the case of AC power, the power could be real power, reactive (inductive or capacitive) power, or a combination of real and reactive power.

“Power conversion modes” means all the modes described herein in which PCMs may operate, including an inductive mode (PCM absorbs an amount of reactive power Q_{VAR}), a capacitive mode (PCM supplies an amount of reactive power Q_{VAR}), an efficient power mode (PCM is restricted to converting an amount of power P_{EFF}), a variable power mode (PCM operates to convert a variable amount of power responsive to system requirements), a standby mode (PCM does not convert any power), an equal power mode (PCM converts a power of P_{REQ}/N−1), a power maximization mode (PCM operates to maximize the output power of the power source), an equal power MPPT mode (PCM converts a power of MOD(P_{REQ}/N−1), a complex power mode (PCM produces a combination of reactive and real power that sums to its maximum power capacity), and a self-test mode (PCM tests its ability to perform in the other various modes).

“Communication bus” means a bus that is used for operatively connecting the PCMs together. It is also used for operatively connecting a modular converter mode control module to the PCMs and is, thus, also referred to as a control bus whenever a modular converter mode control module is utilized.

“Power conversion” means converting one form of electrical power to another, such as, for example, AC to DC or DC to AC as well as correcting the power factor in the presence of large reactive loads.

FIG. 1 is a block diagram of one embodiment of a bidirectional MPC. MPC 100 comprises a plurality of power conversion modules (PCMs) 110₁, 110₂, . . . 110_{N} coupled to control bus 120, via connections 105₁, 105₂, . . . 105_{N}, a first power bus 122, via connections 127₁, 127₂, . . . 127_{N}, and a second power bus 124 via connections 129₁, 129₂, . . . 129_{N}. In one example of operation, PCMs 110₁, 110₂, . . . 110_{N} have substantially equal power conversion capacities and are bidirectional. They can sense and receive power from first power bus 122 and output it to second power bus 124 and can sense and receive power from second power bus 124 and output power to first power bus 122. First and second power buses 122, 124 could be DC or AC buses. PCMs 110₁, 110₂, . . . 110_{N} could receive or supply DC or AC power. In the case of AC power, the power could be real power, reactive power, or a combination of real and reactive power. In the case that first or second power buses 122, 124 are AC power buses, they could be single phase or multiphase buses. First and second power buses 122, 124 could connect to electrical loads, to an electrical grid, a power generating component such as, for example a diesel generator, hydroelectric generator, photovoltaic (PV) panel or panel array, a wind turbine, or wind turbine array. First and second power buses 122, 124 could also connect to electrical storage devices such as for example, a fuel cell or a battery. The external loads and power generating examples are not shown in the drawings.

Each PCM 110₁, 110₂, . . . 110_{N} could be capable of performing the complete power conversion function of MPC 100. For example, if MPC 100 is a bidirectional three phase DC to AC converter, capable of converting three phase AC power to DC power and DC power to three phase AC power, then each PCM 110₁, 110₂, . . . 110_{N} could also be capable of converting three phase AC power to DC power and DC power to three phase AC power.

In some embodiments, each PCM 110₁, 110₂, . . . 110_{N} could be capable of performing part of the power conversion function of the complete MPC 100. For example, if MPC 100 is a bidirectional three phase DC to AC converter, capable of converting three phase AC power to DC power and DC power to three phase AC power, then each PCM 110₁, 110₂, . . . 110_{N} could be capable of converting a single phase of the three phase AC power to DC power and DC power to a single phase of the three phase AC power. In this case, the number of PCMs 110₁, 110₂, . . . 110_{N} in MPC 100 is a multiple of three.

In this embodiment, MPC 100 could perform a phase balancing function by providing differing amounts of power to each of the three phases. Phase balancing could be especially useful in a microgrid where large, single phase loads could otherwise unbalance the phases of the microgrid. In phase balancing, differing amounts of power are provided to each phase to maintain the root mean square (RMS) voltage values of the different phases substantially equal.

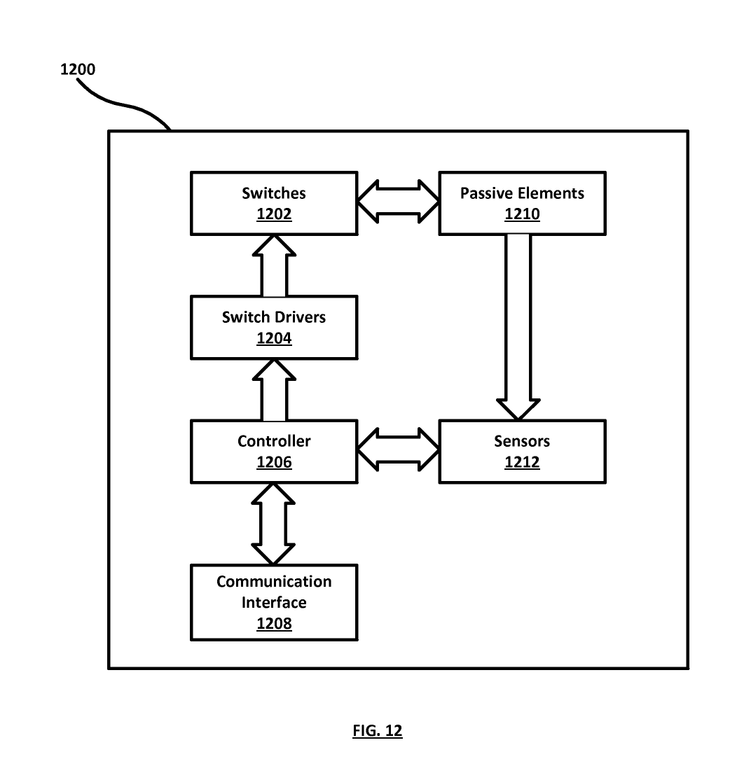

MPC mode control module 140 is coupled to control bus 220 via connection 116 for the selection and coordination of the operating modes of PCMs 110₁, 110₂, . . . 110_{N}. MPC mode control module 140 is further described with respect to FIG. 11. PCMs 110₁, 110₂, . . . 110_{N} are capable of converting power autonomously. This means that once a PCM is set to a particular operating mode by MPC mode control module 140, the PCM does not require any further control signals from MPC mode control module 140 to perform the power conversion function of that mode. PCMs 110₁, 110₂, . . . 110_{N} are capable of sensing the condition of first and/or second power buses 122, 124 and responding appropriately. For example, if second power bus 124 is an AC bus with a mandatory voltage range then PCMs 110₁, 110₂, . . . 110_{N} are capable of sensing the AC frequency and phase and outputting AC power at that frequency and phase to maintain the voltage within the mandatory range. PCMs 110₁, 110₂, . . . 110_{N} can also operate independently of one another. One PCM may be in one operating mode while another PCM may be in a different mode. For example, one PCM may be in a standby mode and may not be converting power while another PCM may be in a different mode and could be converting power.

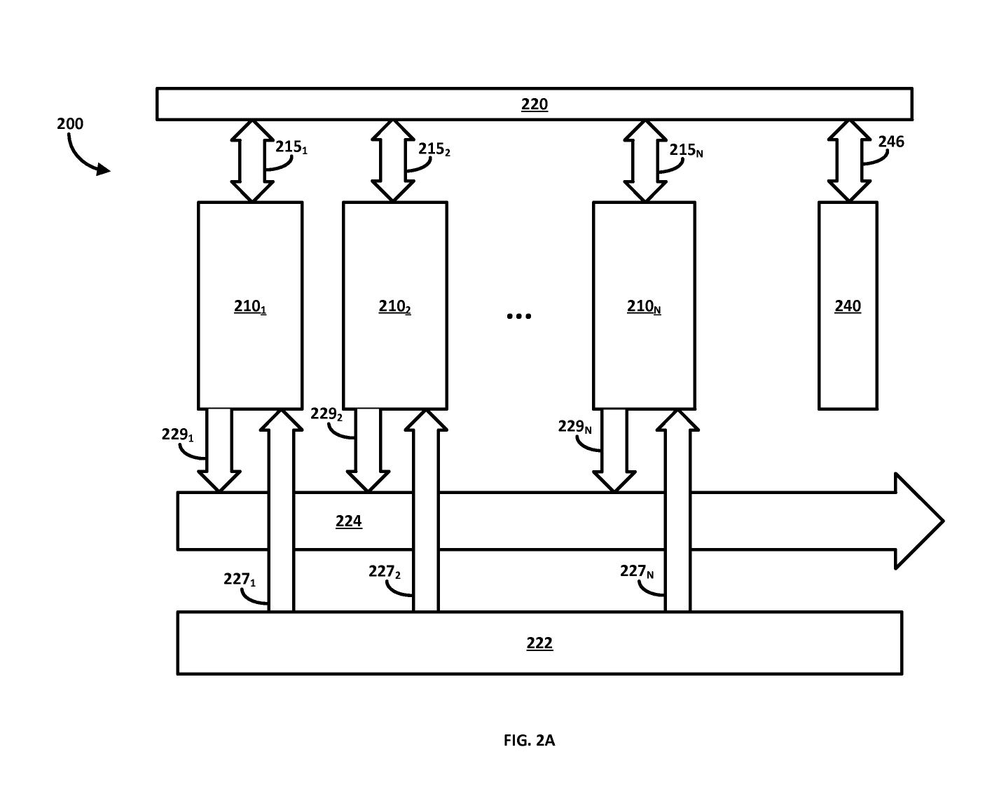

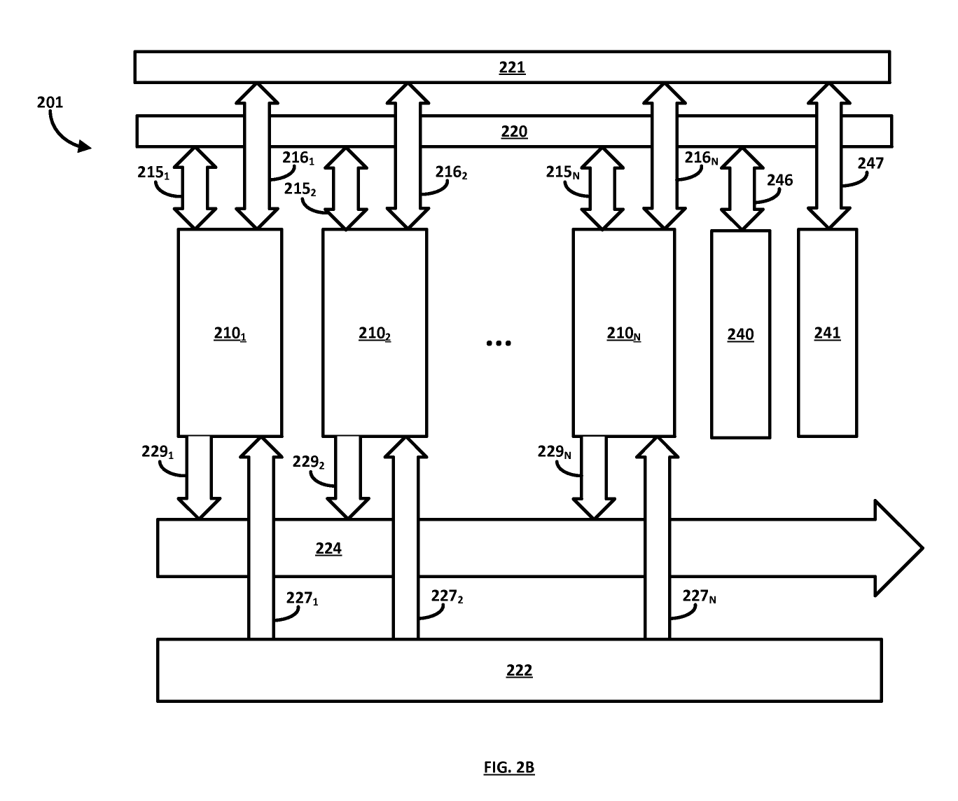

FIG. 2A, with reference to FIG. 1, is a block diagram of a unidirectional MPC 200. MPC 200 comprises a plurality of power conversion modules (PCMs) 210₁, 210₂, . . . 210_{N} coupled to control bus 220, via connections 215₁, 215₂, . . . 215_{N}, a first power bus 222, via connections 227₁, 227₂, . . . 227_{N}, and a second power bus 224, via connections 229₁, 229₂, . . . 229_{N}. In one exemplary mode of operation, PCMs 210₁, 210₂, . . . 210_{N} have substantially equal power conversion capacities and are unidirectional. They receive power from input power bus 222 and output it to output power bus 224. Input and output power buses 222, 224 could be DC or AC buses. Input power bus 222 could connect to a power generating component such as, for example a diesel generator, hydroelectric generator, PV panel or panel array, a wind turbine, or wind turbine array. Input power bus 222 could also connect to an electrical grid or electrical storage devices such as for example, a fuel cell or a battery. Output power bus 224 could connect to an electrical load or to an electrical grid. Output power bus 224 could also connect to electrical storage devices such as for example, a fuel cell or a battery.

PCMs 210₁, 210₂, . . . 210_{N} could receive DC or AC power and could output DC or AC power. MPC 200 could therefore be a rectifier, an inverter, a DC to DC converter or an AC to AC converter. In the case of AC power, the power could be real power, reactive power, or a combination of real and reactive power. In the case that first or second power buses 222, 224 are AC power buses, they could be single phase or multiphase buses. Each PCM 210₁, 210₂, . . . 210_{N} could be capable of performing the complete power conversion function of MPC 200. For example, if MPC 200 is a unidirectional single phase DC to AC converter capable of converting DC power to single phase AC power, then each PCM 210₁, 210₂, . . . 210_{N} could also be capable of converting DC power to three phase AC power.

In some embodiments, each PCM 210₁, 210₂, . . . 210_{N} could be capable of performing part of the power conversion function of the MPC 200. For example, if MPC 200 is a unidirectional DC to three phase AC inverter, capable of converting DC power to three phase AC power, then each PCM 210₁, 210₂, . . . 210_{N} could be capable of converting DC power to single phase AC power. In this case, the number of PCMs 210₁, 210₂, . . . 210_{N} in MPC 200 is a multiple of three.

In this embodiment, MPC 200 could perform a phase balancing function by providing differing amounts of power to each of the three phases. Phase balancing could be especially useful in a microgrid where large, single phase loads could otherwise unbalance the microgrid.

MPC mode control module 240 is coupled to control bus 220 via connection 246 for the selection and coordination of the operating modes of PCMs 210₁, 210₂, . . . 210_{N}. MPC mode control module 240 is further described with respect to FIG. 11. PCMs 210₁, 210₂, . . . 210_{N} are capable of converting power autonomously. This means that once a PCM is set to a particular operating mode by MPC mode control module 240 it does not require any further control signals from controller 240 to perform the power conversion function of that mode. PCMs 210₁, 210₂, . . . 210_{N} are capable of sensing the condition of first and/or second power buses 222, 224 and responding appropriately. For example, if second power bus 224 is an AC bus with a voltage range, then PCMs 210₁, 210₂, . . . 210_{N} are capable of sensing the AC frequency and phase and outputting AC power at that frequency and phase to maintain the voltage within the mandatory range. PCMs 210₁, 210₂, . . . 210_{N} can also operate independently of one another. One PCM may be in one operating mode while another PCM may be in a different mode. For example, one PCM may be in a standby mode and may not be converting power while another PCM may be in a different mode and could be converting power.

FIG. 2B, with reference to FIGS. 1 through 2A, is a block diagram of a unidirectional MPC 201. MPC 201 is similar to MPC 200 shown in FIG. 2A with the addition of a redundant control bus 221 coupled to a redundant mode control module 241 via connection 247. MPC 201 comprises a plurality of PCMs 210₁, 210₂, . . . 210_{N} coupled to control bus 220, via connections 215₁, 215₂, . . . 215_{N}, control bus 221 via connections 216₁, 216₂, . . . 216_{N}, a first power bus 222, via connections 227₁, 227₂, . . . 227_{N}, and a second power bus 224, via connections 229₁, 229₂, . . . 229_{N}.

VAr Compensator

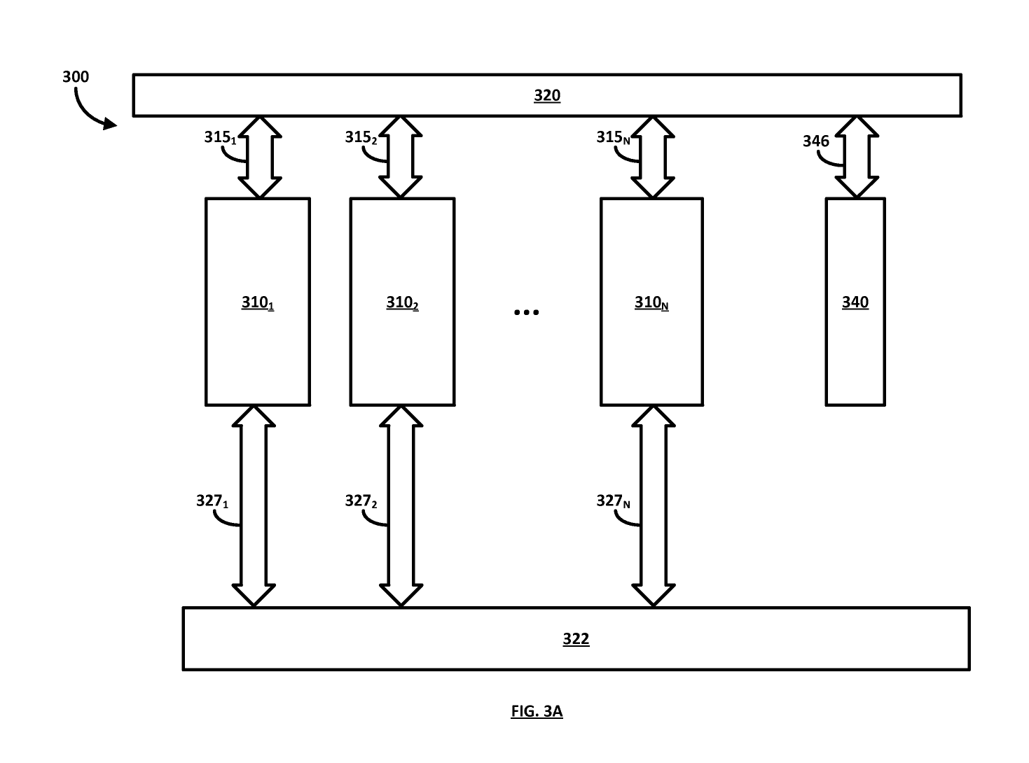

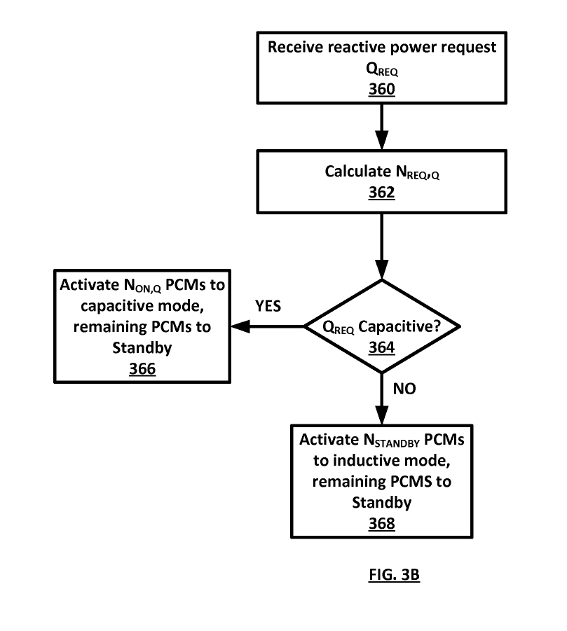

FIG. 3A, with reference to FIGS. 1 through 2B, is a block diagram of another embodiment of a MPC which functions as a VAr compensator. MPC 300 (which shall be referred to herein as a VAr compensator 300 for clarity) comprises a plurality of PCMs 310₁, 310₂, . . . 310_{N} coupled to a control bus 320 via connections 315₁, 315₂, . . . 315_{N}, and a first power bus 322 via connections 327₁, 327₂, . . . 327_{N}. In this example, PCMs 310₁, 310₂, . . . 310_{N} have substantially equal VAr production capacities and are operated in such a way that any particular PCM is either on (i.e., inductive mode or capacitive mode) or off (i.e., standby mode). VAr compensator 300 could consume or provide reactive power from or to power bus 322, depending on the requirement. Power bus 322 is an AC bus. Power bus 322 could be single phase or multiphase. Power bus 322 could connect to an electric grid such as, for example. a utility grid, or a microgrid such as, for example, inside a large industrial facility.

MPC mode control module 340 is coupled to control bus 320 via connection 346 for the control of PCMs 310₁, 310₂, . . . 310_{N}. Each PCM 310₁, 310₂, . . . 310_{N} could be capable of performing the complete power conversion function of VAr compensator 300. For example, if VAr compensator 300 is a three phase VAr compensator, capable of converting DC power to single phase AC power, then each PCM 310₁, 310₂, . . . 310_{N} could also be capable of converting DC power to three phase AC power.

Alternatively, each PCM 310₁, 310₂, . . . 310_{N} could be capable of performing part of the power conversion function of VAr compensator 300. For example, PCMs 310₁, 310₂, . . . 310_{N} could be single phase VAr compensators and could supply or consume reactive power to or from one phase of a multiphase bus. MPC 300 could be a three phase VAr compensator and PCMs 310₁, 310₂, . . . 310_{N} could individually supply or consume reactive power from or to the three phases of bus 322. In some embodiments, an equal number of PCMs 310₁, 310₂, . . . 310_{N} could be connected to each phase of the bus 322. In other embodiments, 310₁, 310₂, . . . 310_{N} could be switchably connected to all phases to allow any PCM to supply or consume power from any phase of the power bus 322.

Efficient VAr Compensation Method

The modular nature of VAr compensator 300 could allow for a simplified design of PCMs 310₁, 310₂, . . . 310_{N}. In one alternative mode of operation, PCMs 310₁, 310₂, . . . 310_{N} have only three power conversion operating modes: standby mode in which they do not produce or consume reactive power, inductive mode in which they absorb a fixed quantity of reactive power of magnitude Q_{VAR}, and capacitive mode in which they supply a fixed quantity of reactive power of magnitude Q_{VAR}. In this mode of operation, the PCMs 310₁, 310₂, . . . 310_{N} have only three static operating points and can be configured for optimal efficiency at these operating points.

FIG. 3B, with reference to FIGS. 1 through 3A, is a flowchart of an efficient VAr compensation method in the case where VAr compensator 300 is single phase. A request to supply a quantity of reactive power (Q_{REQ}) is received at step 360. The required number of PCMs 310₁, 310₂, . . . 310_{N} (N_{REQ,Q}) to meet the requirement is calculated at step 362 where N_{REQ,Q}=MOD (Q_{REQ}/Q_{VAR}+0.5). At step 364 it is determined whether the reactive power request is for capacitive or inductive power. If the request is for capacitive power, then N_{REQ,Q} PCMs are put into capacitive mode at step 366 while the remaining PCMs are put into standby mode. If the request is for inductive power, then N_{REQ,Q} PCMs are put into inductive mode at step 368 and the remaining PCMs are put into standby mode. MPC 300 could meet the reactive power requirement to within a maximum error of ±Q_{VAR}/2.

In the efficient VAr compensation method, the selection of the PCMs to be in inductive, capacitive, or standby modes could be performed by mode control module 340. In the case where VAr compensator 300 is multiphase, the same method described above could be applied on a phase-by-phase basis. In response to a request to supply a quantity of reactive power Q_{REQ,n} to 0 the n-th phase of a multiphase bus, a number (N_{REQ,n}) of PCMs 310₁, 310₂, . . . 310_{N} connected to the n-th phase of the multiphase bus could be set to either capacitive or inductive mode where N_{REQ,n}=MOD(Q_{REQ,n})/Q_{VAR}+0.5). The remaining PCMs connected to the n-th phase of the bus could be set to standby.

AC Battery Storage System

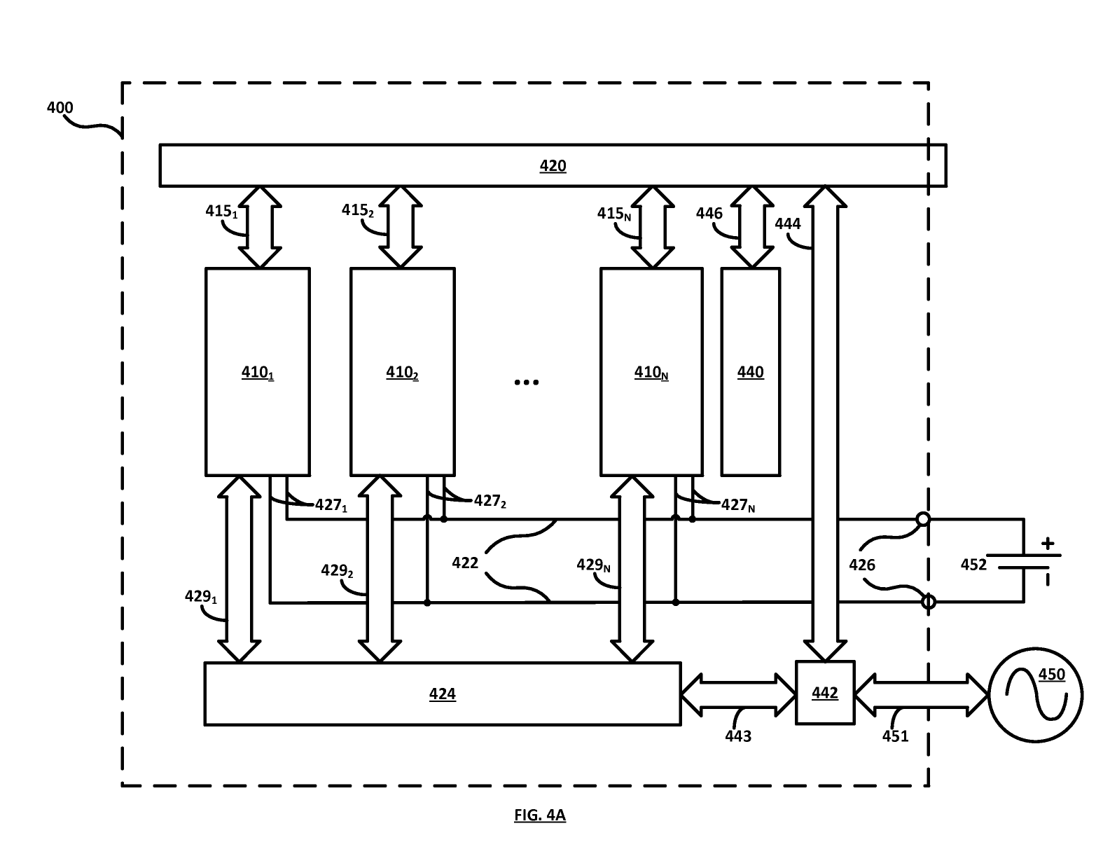

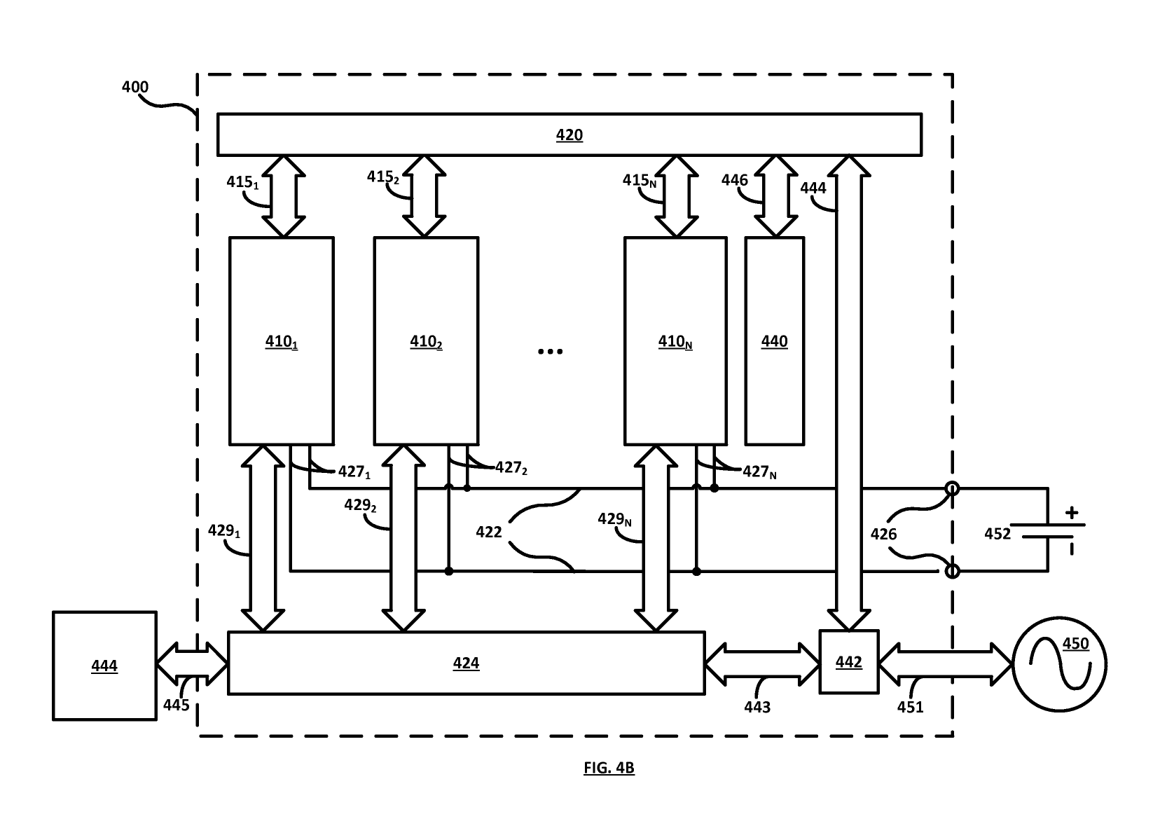

FIG. 4A, with reference to FIGS. 1 through 3B, is a block diagram of another embodiment of a MPC 400 which functions as an AC battery storage system. MPC 400 comprises a plurality of PCMs 410₁, 410₂, . . . 410_{N} coupled to a control bus 420 via connections 415₁, 415₂, . . . 415_{N}, a first DC power bus 422, via connections 427₁, 427₂, . . . 427_{N}, a second AC power bus 424 via connections 429₁, 429₂, . . . 429_{N}. MPC 400 has an islanding switch module 442 operatively connected to AC power bus 424 via connection 443 and to control bus 420 via connection 444 and terminal pair 426 connecting to DC power bus 422. MPC 400 is coupled to electrical grid 450 through islanding switch module 442 via connection 451 and coupled to battery 452 at terminal pair 426. Electrical grid 450 could be a utility grid or a microgrid such as at a large industrial facility at an off-grid location. Various loads and power generators could be connected to electrical grid 450. Power generators could include diesel generators or renewable power sources (not shown). In this embodiment, PCMs 410₁, 410₂, . . . 410_{N} are bidirectional and have substantially equal power conversion capacities. In this example, PCMs 410₁, 410₂, . . . 410_{N} either receive AC power from electrical grid 450 through AC power bus 424 and output DC power to battery 452 through DC power bus 422 or receive DC power from battery 452 and output AC power to electrical grid 450. AC supplied to power bus 424 could be single phase or multiphase. Islanding switch module 442 could disconnect MPC 400 from grid 450 in the event of a power outage to prevent grid 450 from being unintentionally energized.

Each PCM 410₁, 410₂, . . . 410_{N} could be capable of performing the complete power conversion function of MPC 400. For example, if MPC 400 id a three phase battery management system, capable of converting DC power to three phase AC power and three phase AC power to DC power then each PCM 410₁, 410₂, . . . 410_{N} could be capable of converting DC power to three phase AC power and three phase AC power to DC power. Alternatively, each PCM 410₁, 410₂, . . . 410_{N} could be capable of performing part of the power conversion function of MPC 400. For example, PCMs 410₁, 410₂, . . . 410_{N} could be single phase bidirectional converters and could individually supply or consume power to or from one phase of a multiphase bus. In some embodiments, an equal number of PCMs 410₁, 410₂, . . . 410_{N} could be connected to each phase of the multiphase bus. In another embodiment, PCMs 410₁, 410₂, . . . 410_{N} are switchably connected to all phases of the multi-phase bus to allow any PCM to supply power to phase of the power bus.

MPC mode control module 440 is coupled to control bus 420 via connection 446 for the selection and coordination of the operating modes of PCMs 410₁, 410₂, . . . 410_{N} and the charging and maintenance of battery 452. PCMs 410₁, 410₂, . . . 410_{N} are capable of converting power autonomously. This means that once a PCM is set to a particular operating mode by MPC mode control module 440 it does not require any further control signals from MPC mode control module 440 to perform the power conversion function of that mode. PCMs 410₁, 410₂, . . . 410_{N} are capable of sensing the condition of first or second power buses 422, 424 and responding appropriately. For example, PCMs 410₁, 410₂, . . . 410_{N} are capable of sensing the voltage of DC bus 422 and supplying power to maintain that voltage. PCMs 410₁, 410₂, . . . 410_{N} can also operate independently of one another. One PCM may be in one operating mode while another PCM may be in a different mode. For example, one PCM may be in a standby mode and may not be converting power while another PCM may be in a different mode and could be converting power.

Uninterruptable Power Supply

MPC 400 might also be employed as part of an uninterruptible power supply (UPS). FIG. 4B, with reference to FIGS. 1 through 4A, is a block diagram of an MPC forming part of a UPS. AC power bus 424 connects directly to local load 444 via connection 445 and to electrical grid 450 through disconnect switch 442. In normal operation, MPC converts AC power from grid 450 into DC power to charge or maintain battery 452. In the event of a power outage on grid 450, islanding switch module 442 opens and disconnects MPC 400 from grid 450. MPC 400 then receives DC power from battery 452 and supplies AC power to load 444 ensuring continued operation of load 444.

Multi-Function

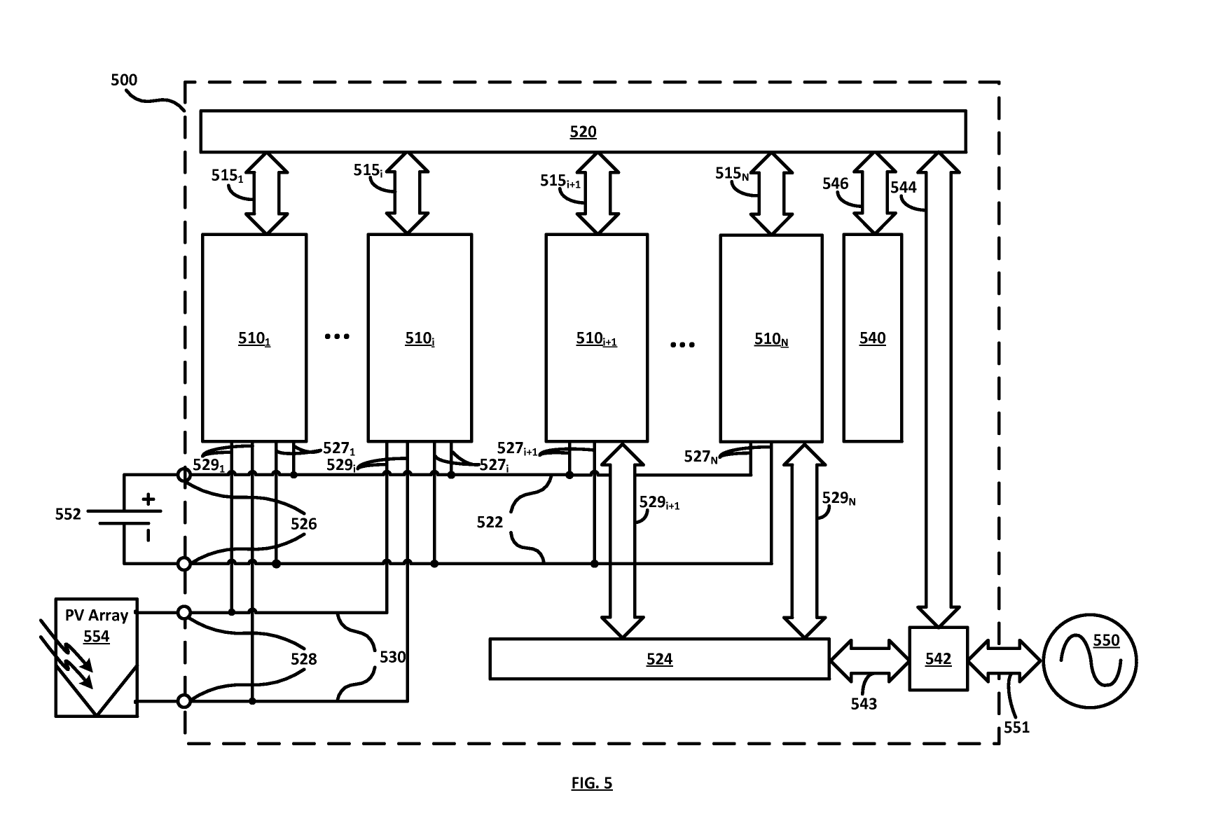

The modular nature of an MPC could allow it to perform multiple power conversion functions by combining different types of PCMs. FIG. 5, with reference to FIGS. 1 through 4B, is a block diagram of an example MPC forming part of a battery backed photovoltaic power system. MPC 500 comprises a plurality of PCMs 510₁ . . . 510ᵢ, and 510ᵢ₊₁ . . . 510_{N}, coupled to a control bus 520, via connections 515₁, . . . 515ᵢ, and 515ᵢ₊₁, . . . 515_{N}, and a first DC power bus 522, via connections 527₁ . . . 527ᵢ, and 527ᵢ₊₁ . . . 527_{N}. PCMs 510ᵢ₊₁ . . . 510_{N} are coupled to a first AC power bus 524, via connections 529ᵢ₊₁ . . . 529_{N}. PCMs 510₁ . . . 510i are coupled to a second DC power bus 530, via connections 529₁ . . . 529ᵢ. MPC mode control module 540 is coupled to control bus 520 via connection 546 for the selection and coordination of the operating modes of PCMs 510₁ . . . 510_{N}. Islanding switch module 542 is coupled to control bus 520 via connection 544, to electrical grid 550 via connection 551 and to AC power bus via connection 543. MPC 500 also includes terminal pairs 526 for connecting to battery 552 and terminal pairs 528 for connecting to PV array 554. Electrical grid 550 could be the utility grid or a microgrid such as at a large industrial facility at an off-grid location. Various loads and power generators could be connected to electrical grid 550. PV array 554 could be a single PV panel, a string of panels, or multiple strings of panels.

In this example, MPC 500 comprises two different types of PCMs. PCMs 510₁ . . . 510ᵢ are DC to DC converters and convert the variable DC voltage of PV panel array 554 to a DC voltage suitable for charging battery 552. PCMs 510ᵢ₊₁ . . . 510_{N} are bidirectional DC to AC converters. They could convert the DC voltage of battery 552 to an AC voltage to supply power to electrical grid 550 or convert the AC voltage of electrical grid 550 to a DC voltage suitable for charging battery 552. PCMs 510₁ . . . 510ᵢ and PCMs 510ᵢ₊₁ . . . 510_{N} could be physically different modules with different circuit topologies and components or they could be physically identical modules and only controlled differently to function as DC to DC and DC to AC converters. PCMs 510₁, 510₂, . . . 510_{N} are capable of converting power autonomously. This means that once a PCM is set to a particular operating mode by MPC mode control module 540 it does not require any further control signals from MPC mode control module 540 to perform the power conversion function of that mode.

Customization

The modular nature of MPC 100, 200, 300, 400 could make it easily customizable to a specific power conversion capacity requirement. In one exemplary mode of operation PCMs 110, 210, 310, 410 (PCMs are numbered herein without their subscripts for the sake of brevity and it should be understood that in this case the numbering without the subscript refers to all PCMs, e.g. 110 refers to PCMs 110₁, 110₂, . . . 110_{N}) could be capable of performing the complete power conversion function of their respective MPC 100, 200, 300, 400 and could all have substantially equal power conversion capacities “P_{PCM}”. If an application requires a maximum power conversion capacity of “C”, then the required number “K” of PCMs 110, 210, 310, 410 in MPC 100, 200, 300, 400 is:

$$K = MOD ( \frac{C}{{P}_{PCM}} ) + 1$$

For example, if a power conversion capacity of 50 kW is required, an MPC 100, 200, 400 could be provided comprising of one hundred PCMs 110, 210, 410 each with a capacity of 500 W. If a reactive power capacity of 50 kVAr is required, a VAr 300 compensator could be provided comprising of one hundred PCMs 310 each with a capacity of 500VAr.

The requisite number of PCMs could be assembled into a MPC more quickly and with less design effort compared to a custom designed monolithic power converter. The modular nature of a MPC could make it easily customizable to meet specific system requirements by combining PCMs of different types. For example, if a system requirement is the conversion of a quantity of DC power to AC power but also the supply of a quantity of reactive power, then an MPC could be readily assembled using the appropriate number of DC to AC and VAr compensator PCMs along with the required mode controller or islanding switch modules. For example, if the AC battery storage system of FIG. 4A is required to supply reactive power to electrical grid 450, then additional VAr compensator PCMs could be installed in MPC 400 to meet this requirement.

The modular nature of MPC 100, 200, 300, 400, 500 could also make it easily scalable with increasing conversion requirements. The power conversion capacity of MPC 100, 200, 300, 400, 500 could be increased simply by adding additional PCMs 110, 210, 310, 410, 510. This could require less effort, expense, and time than the alternative of replacement of an existing monolithic converter with a larger capacity monolithic converter. MPC 100, 200, 300, 400, 500 could be more tolerant of component failure than a monolithic power converter. In a monolithic power converter, the failure of a single component can cause the converter to fail. In MPC 100, 200, 300, 400, 500 the failure of a single PCM 110, 210, 310, 410, 510 could only result in the loss of the failing PCM's conversion capacity rather than the loss of the complete power conversion capacity of the entire MPC 100, 200, 300, 400, 500.

The failure of MPC mode control module 140, 240, 340, 440, 540 could however, cause MPC 100, 200, 300, 400, 500 to fail. In some embodiments of the MPC, multiple MPC mode control modules and control buses are used to provide redundancy and prevent a failure of the MPC from a single MPC mode control module failure. Again with reference to FIG. 2B, which is a block diagram of a unidirectional MPC with a redundant control bus and mode control module, MPC 201 comprises redundant control module 241 and redundant control bus 221. In the event of the failure of mode control module 240 and/or control bus 220, mode control module 241 can control the operating modes of PCMs 210₁ . . . 210_{N}.

Physical Design

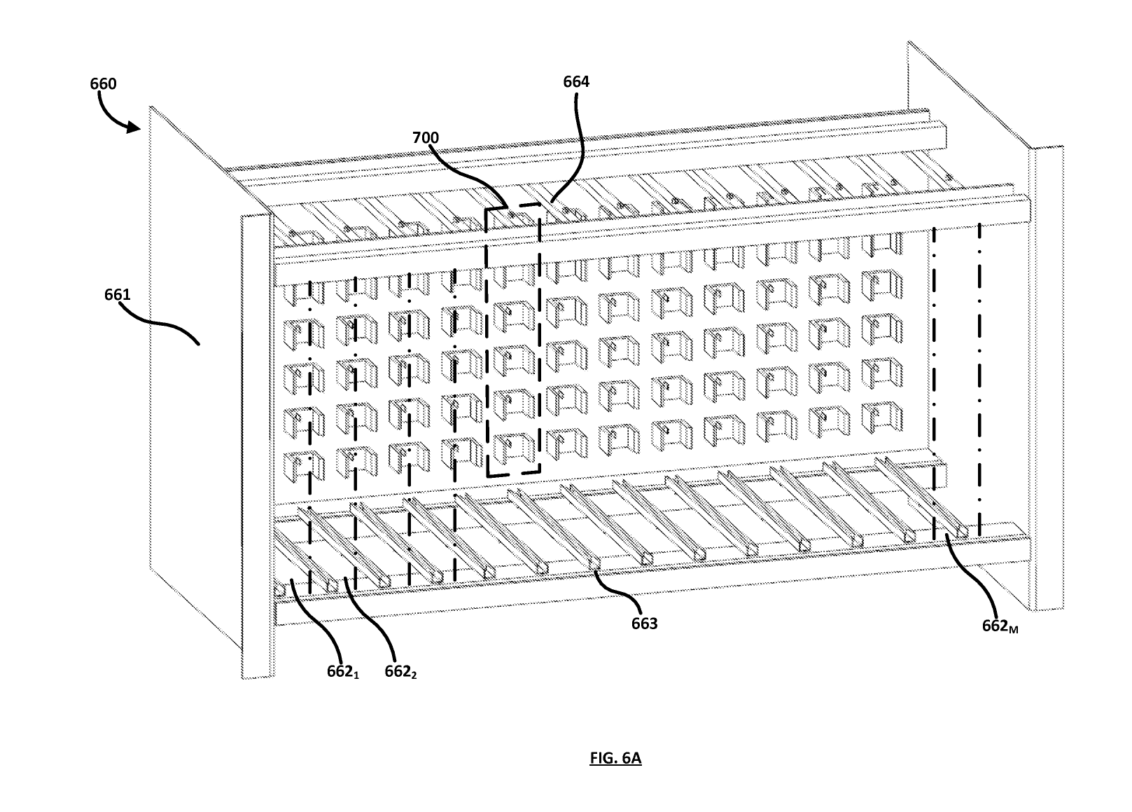

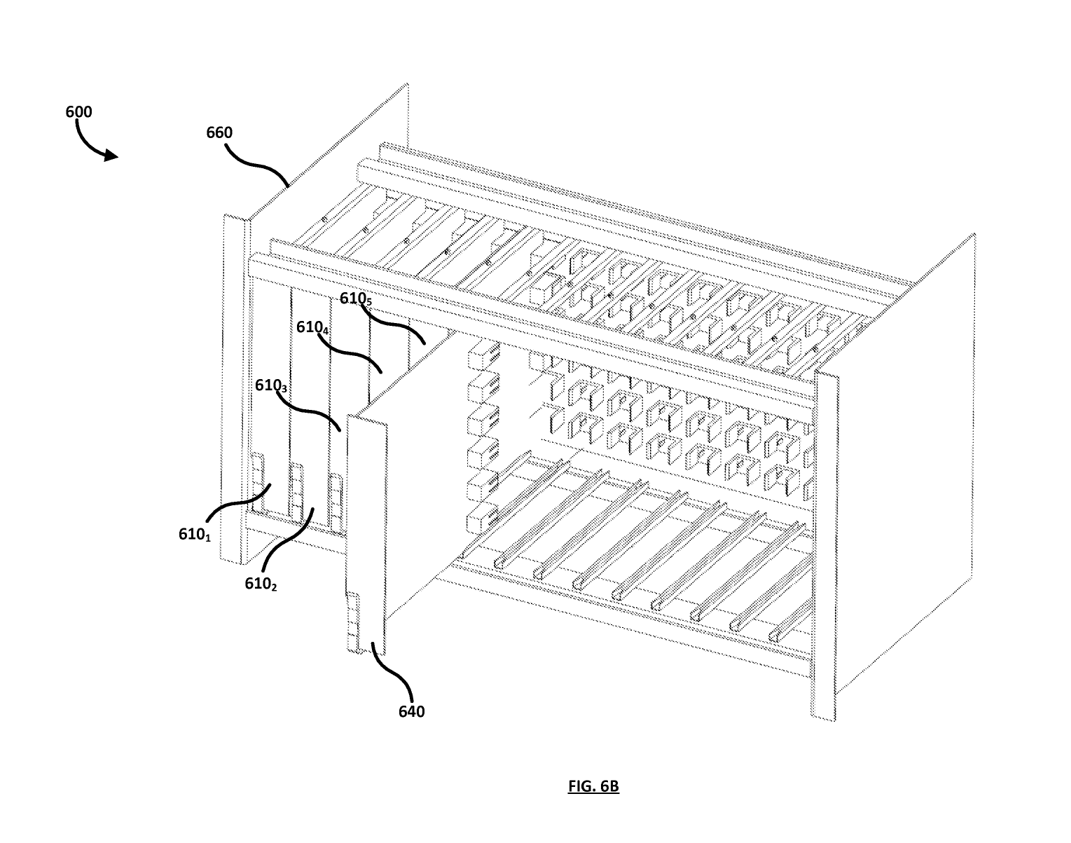

The modular design of MPCs 100, 200, 300, 400, 500 could make their physical implementation compatible with a rack and cabinet design in which the various MPC modules (including PCMs, MPC mode control modules or islanding switch modules) are rack mountable and their electrical interconnection is supplied by the mounting rack. FIG. 6A, with reference to FIGS. 1 through 5, is a drawing of an example of a power shelf racking system. Power shelf 660 comprises metal chassis 661 and vertical slots 662₁, 662₂, . . . 662_{M} into which PCMs 110, 210, 310, 410, 510, MPC mode control module 140, 240, 340, 440, 540, or islanding switch module 442, 542 could be inserted and physically secured. Each slot 662₁, 662₂, . . . 662_{M} contains guide rails 663, 664 to guide and support a module when it is inserted or removed from the power shelf. Each slot contains slot connector arrangement 700 to which PCMs 110, 210, 310, 410, 510, MPC mode control modules 140, 240, 340, 440, 540, islanding switch module 442, 542, or any other MPC modules could be plugged into to make electrical contact to control buses 120, 220, 320, 420, 520 (not shown) and power buses 122, 124, 222, 224, 322, 422, 424, 522, 524, 530 (not shown).

Slots 662₁, 662₂, . . . 662_{M} could be of identical physical dimensions (width, depth, and height) and PCMs 110, 210, 310, 410, 510, MPC mode control modules 140, 240, 340, 440, 540, and islanding switch module 442, 542 could have compatible physical dimensions such that they or any other MPC modules could be inserted in any slot 662₁, 662₂, . . . 662_{M}. Alternately, modules might be sized as multiples of the slot width such that a module could occupy an integer multiple of slots.

FIG. 6B, with reference to FIGS. 1 through 6A, is a drawing of an MPC designed as a power shelf. MPC 600 comprises PCMs 610₁, 610₂, . . . 610₅, MPC mode control module 640, and power shelf 660. In FIG. 6B, the first five slots of power shelf 660 are filled with PCMs 610₁, 610₂, . . . 610₅ and the sixth slot is filled with MPC mode control module 640. The remaining slots in power shelf 660 are empty. The power conversion capacity of MPC 600 could be easily increased if required by adding more PCMs to fill the empty slots.

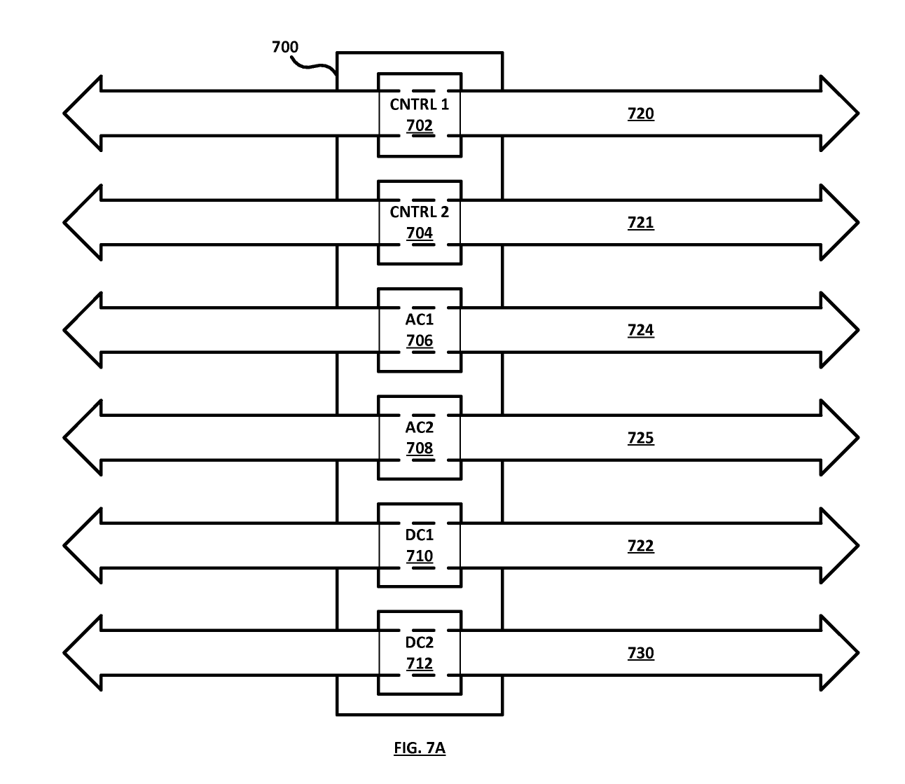

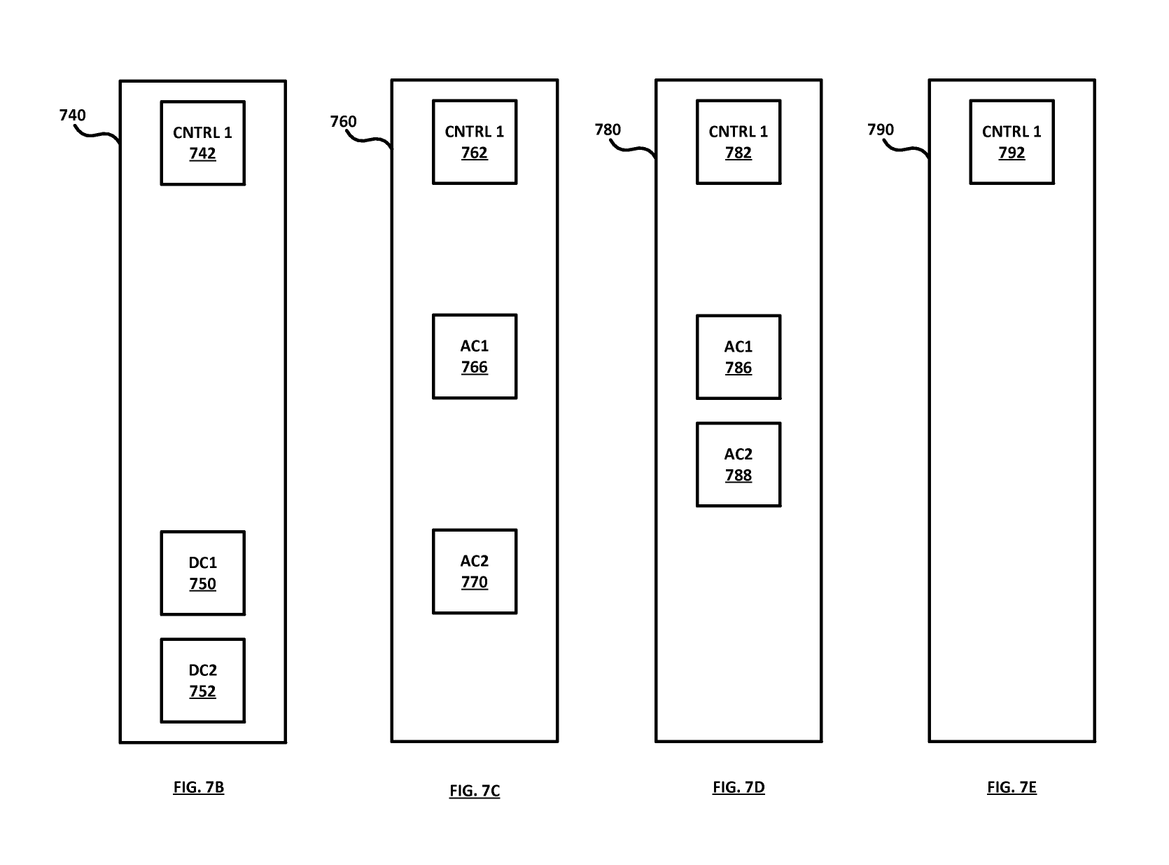

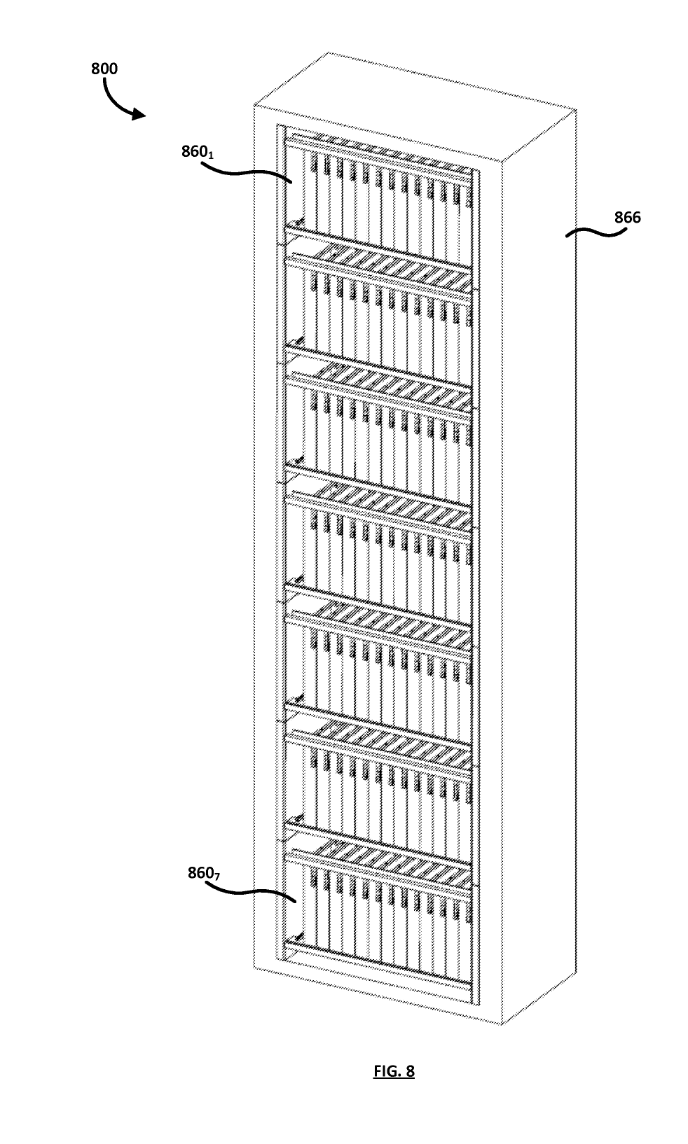

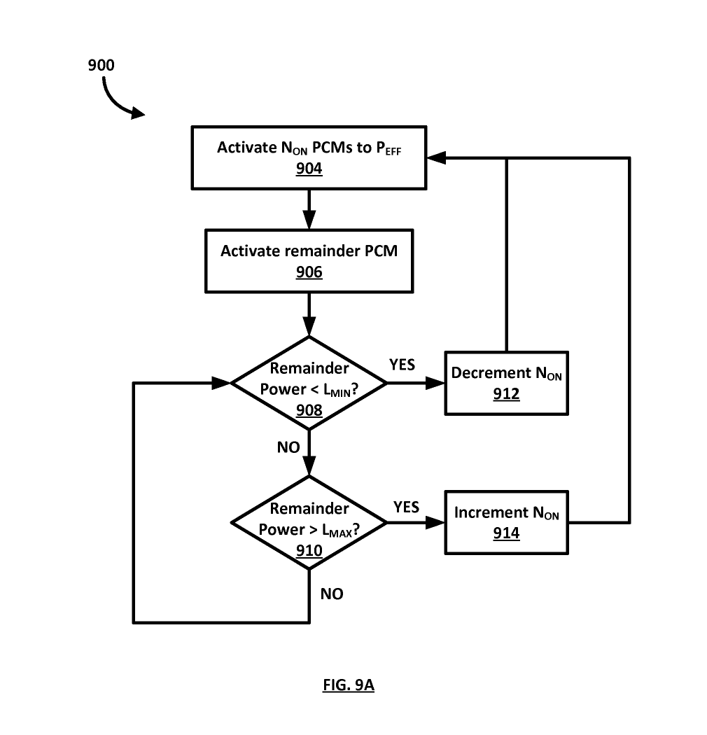

FIG. 7A, with reference to FIGS. 1 through 6B, is a drawing of an example slot connector arrangement for a single slot of a power shelf. Slot connector arrangement 700 comprises electrical connectors 702, 704, 706, 708, 710, 712 which could mate with a corresponding module connector arrangement on an MPC module. In this example, connector 702 provides connections to a first control bus 720. Connector 704 provides connections to a second, optional control bus 721. Connector 706 provides connections to a first AC power bus 724. Connector 708 provides connection to a second external AC bus 725. Connector 710 provides connection to first DC bus 722 and connector 712 provides connection to a second DC bus 730. In one embodiment of power shelf 660 and slots 662₁ . . . 662_{M} all have identical slot connector arrangements.

For MPC 500 of FIG. 5 implemented in a power shelf 660, connector 702 could provide connection to control bus 540, connector 706 could provide connection to AC power bus 524, connector 708 could provide connection to electrical grid 550, connector 710 could provide connection to DC bus 522 and connector 712 could provide connection to DC bus 530.

FIG. 7B, with reference to FIGS. 1 through 7A, is a drawing of an example module connector arrangement for the DC to DC PCMs of FIG. 5. PCMs 510₁ . . . 510ᵢ all have module connector arrangement 740. Module connector arrangement 740 comprises connectors 742, 750, and 752 which mate with connectors 702, 710, and 712, respectively, of slot connector arrangement 700. The absence of a connector in an MPC module's module connector arrangement results in no connection. For example, for an MPC module using module connector arrangement 740 there would be no direct connection between the MPC module and connectors 704, 706, or 708 of slot connector arrangement 700 or to buses 721, 724, or 725.

FIG. 7C, with reference to FIGS. 1 through 7B, is a drawing of an example module connector arrangement for the DC to AC PCMs of FIG. 5. PCMs 510ᵢ₊₁ . . . 510_{N} all have module connector arrangement 760. Module connector arrangement 760 comprises connectors 762, 766, and 770 which mate with connectors 702, 706, and 710, respectively, of slot connector 700.

FIG. 7D, with reference to FIGS. 1 through 7C, is a drawing of an example module connector arrangement for islanding switch module 542 of FIG. 5. Module connector arrangement 780 comprises connectors 782, 786, and 788 which mate with connectors 702, 706, and 708, respectively, of slot connector 700. FIG. 7E, with reference to FIGS. 1 through 7D, is a drawing of an example module connector arrangement for MPC mode control module 540 of FIG. 5. Module connector arrangement 790 comprises connector 792 which mates with connectors 702 of slot connector 700.

Connectors 702, 704, 706, 708, 710, 712, 742, 750, 752, 762, 766, 770, 782, 786, 788, 792 could be implemented with any of a variety of known connector technologies, such as for example, a keyed socket and plug, blade and socket or pin and socket connectors. Control buses 120, 220, 320, 420 and power buses 122, 124, 222, 224, 322, 422, 424 could be physically implemented in rear surface 664 of power shelf 660. Control buses 120, 220, 320, 420 could use any of a variety of known cabling technology such as, for example, ribbon cables or Ethernet cables. Power buses 122, 124, 222, 224, 322, 422, 424 could be physically implemented in a variety of known power technologies such as copper bus bars, stranded insulated wiring or solid insulated wiring. Shelf 660 could be designed to be compatible with any of the standard telecom or computer cabinetry such as but not limited to the Electronic Industries Alliance 310, 19 inch wide cabinet, or the European Telecommunication Standards Institute, 600 mm wide cabinet.

In some embodiments PCMs 610₁, 610₂, . . . 610_{N} and MPC mode control module 640 are “hot swappable” and can be added to power shelf 660 without powering down MPC 600. The modular nature of MPC 600 could also make it easily customizable to a specific power conversion capacity. The requisite number of PCMs could easily be added to power shelf 660 to meet the total power conversion capacity requirement up to the space limit (M) of the shelf. If additional capacity is required a power cabinet comprising of multiple power shelves could be used.

FIG. 8, with reference to FIGS. 1 through 7E, is a drawing of one embodiment of a power cabinet. Power cabinet 800 comprises seven power shelves 860₁ to 860₇. Power shelves 860₁ to 860₇ could be electrically connected through control buses 120, 220, 320, 420 (not shown) and power buses 122, 124, 222, 224, 322, 422, 424 (not shown) running in rear cabinet surface 866. In one embodiment, there is an MPC mode control module 140, 240, 340, 440, 540 for each power shelf 860₁ to 860_{J} for the control of the PCMs in the shelf. In another embodiment an MPC mode control module 140, 240, 340, 440, 540 may control PCMs on other shelves.

The repair of MPC 600 could be simpler and faster than the repair of a monolithic power converter and could simply involve swapping of the failed module for a new module. The spare parts inventory for MPC 600 could also be smaller than for a monolithic converter. For example, the spare parts inventory for MPC 400 of FIG. 4A could comprise only of replacement modules for MPC mode control module 440, PCMs 410, and islanding switch 442.

The production volumes of PCMs 110, 210, 310, 410, 510 could also be larger than the production volumes of monolithic converters. This could allow MPCs 100, 200, 300, 400, 500 to enjoy the cost benefits of automation and volume manufacturing.

Operation

PCMs 110, 210, 310, 410, 510 are capable of converting power autonomously. This means that once a PCMs is set to a particular operating mode by its mode control module it does not require any further control signals from its mode control module to perform the power conversion function of that mode. PCMs 110, 210, 310, 410, 510 are capable of sensing the condition of first and/or second power buses 122, 124, 224, 226, 322, 422, 424, 522, 524 and responding appropriately. For example, in FIG. 1, if bus 124 is an AC bus with a defined voltage then PCMs 110₁, 110₂, . . . 110_{N} are capable of sensing the AC frequency and phase of bus 124 and outputting AC power at that frequency and phase to maintain the defined voltage. PCMs 110, 210, 310, 410, 510 can also operate independently of one another. One PCM may be in one operating mode while another PCM may be in a different mode. For example, one PCM may be in a standby mode and not converting power while another PCM may be in a different mode and could be converting power.

Efficient Power Method

The operation of individual PCMs 110, 210, 310, 410, 510 in MPC 100, 200, 300, 400, 500 could be beneficially coordinated by having mode control module 140, 240, 340, 440, 540 select the PCM operating modes. Coordination could enable power efficient converter operation by only activating enough power conversion capacity to meet the power conversion requirement. In one embodiment, PCMs 110, 210, 410, 510 in MPC 100, 200, 400, 500 are designed to have their point of maximum efficiency P_{EFF} substantially at their maximum power conversion capacity (P). A power converter's efficiency is defined as the ratio of power output divided by power input. A power converter's maximum power conversion capacity is generally specified by the manufacturer and represents the safe operating limit of the converter. For a required amount of total power conversion “P_{REQ}”, a number (N_{ON}) of PCMs 110, 210, 410, 510 could each be restricted to only convert an amount of power P_{EFF} When a PCM is restricted to only convert an amount of power P_{EFF} it is referred to as operating in “efficient power” mode. N_{ON} is given by the formula: N_{ON}=MOD(P_{REQ}/P_{EFF}).

The remaining required power (P_{REQ}−N_{ON}×P_{EFF}) is referred to as the “remainder power” and could be converted by an additional “remainder” PCM 110, 210, 410, 510 operating in a “variable power” mode. When a PCM operates to convert a variable amount of power responsive to system requirements it is referred to as operating in a “variable power” mode. Such system requirements could be, for example, power demand from a load, storage device or electrical grid or power production from a power generator with a variable power output such as, for example, a PV panel array or a wind turbine. Another system requirement could be a reactive power demand from a utility grid or microgrid. The remaining PCMs 110, 210, 410, 510 could operate in a “standby” mode. In standby mode, a PCM does not convert any power. The power dissipation of a PCM in standby mode could be designed to be substantially zero. In the efficient power method, all PCMs not in standby operate at their maximum efficiency except for the remainder PCM operating in variable power mode. The efficiency of the MPC 100, 200, 400, 500 could be maximized with this method.

In one embodiment MPC mode control module 140, 240, 340, 440, 540 is responsible for selecting which PCMs 110, 210, 410, 510 operate in efficient power mode, variable power mode, and standby.

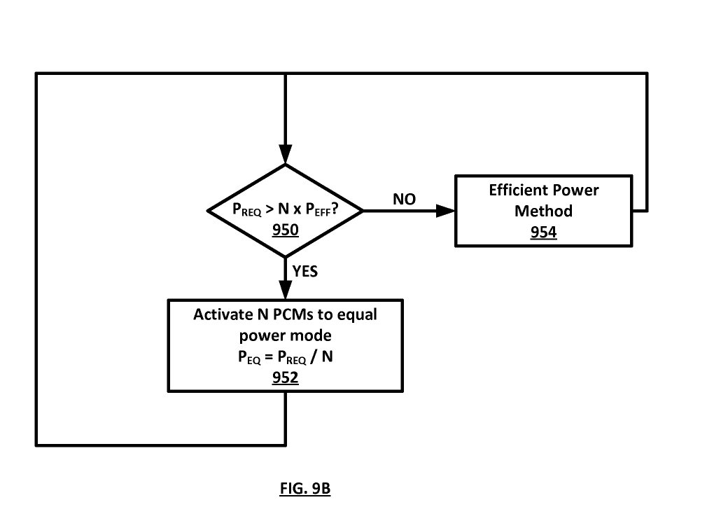

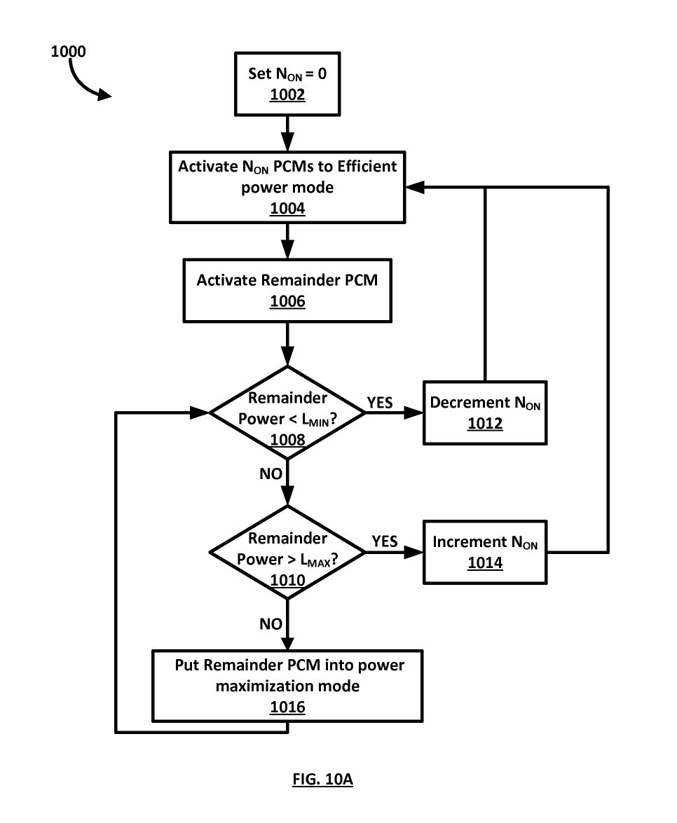

FIG. 9A, with reference to FIGS. 1 through 8, is a flowchart of an efficient power method for operating a MPC. In method 900, N_{ON} PCMs are activated to operate in efficient power mode at step 904. At step 906 the remainder PCM is activated to operate in variable power mode and convert the remainder power. At step 908 it is determined if the power of remainder PCM is below a lower limit (L_{MIN}). If it is below L_{MIN} then the number of PCMs operating in efficient power mode (N_{ON}) is decremented at step 912. If it is not below L_{MIN} then it is determined at step 910 if the power of remainder PCM is above an upper limit L_{MAX}. If it is above L_{MAX} then the number of PCMS operating in efficient power mode (N_{ON}) is incremented at step 914. In one embodiment L_{MIN} is 5% of P_{EFF} and L_{MAX} is 110% Of P_{EFF}.

In another embodiment the remainder power is provided by a special purpose “remainder” PCM which could be optimized to have a flat power efficiency curve across its entire power range rather than a point of maximum efficiency substantially at P_{MAX}.

Equal Power Method

In some embodiments, the maximum efficiency P_{EFF} of PCMs 110, 210, 410, 510 could be sufficiently smaller than their maximum power conversion capacity (P_{MAX}) such that with all PCMs in MPC 100, 200, 400, 500 operating at P_{EFF} there is still significant additional power conversion capacity available to meet a remaining power requirement. In this case, to supply the required power at optimal efficiency, the power requirement could be uniformly distributed over all “N” PCMs in the MPC in an “equal power” method. The power assigned to an individual PCM in the equal power method is (P_{EQ}) where P_{EQ}=P_{REQ}/N.

When a PCM is operated to convert an amount of power P_{EQ} this is referred to as “equal power” mode. FIG. 9B, with reference to FIGS. 1 through 9A, is a flowchart of an equal power method. At step 950 it is determined if the required power P_{REQ} exceeds the maximum efficient power (the power that could be converted by all “N” PCMs operating at P_{EFF}). If P_{REQ} exceeds the maximum efficient power then all “N” PCMs are put into equal power mode and activated to each convert an amount of power P_{REQ}/N at step 952. If P_{REQ} does not exceeded the maximum efficient power then the MPC executes the efficient power method at step 954.

Power Maximization Method

MPC 100, 200, 400, 500 could also be operated in a power maximization method. In the power maximization method, at least one of the PCMs 110, 210, 410, 510 is operated in a “power maximization” mode. In the power maximization mode, the PCM operates to maximize power production of a power generator by varying either its input current or voltage. For example, in an embodiment of unidirectional MPC 200, MPC 200 is an inverter with input power bus 222 operatively connected to a PV panel array. At least one of PCM 210₁, 210₂, . . . 210_{N} could operate a MPPT algorithm/process and vary its input current or input voltage to maximize the power production of the PV panel array by operating the PV panel array at its maximum power point (MPP). The MPP of a PV array is the point on its current versus voltage curve that corresponds to maximum output power. Typically, the MPP will change over the course of a day as the insolation of the panel array changes. An MPPT algorithm locates the MPP of a PV array at the MPP by perturbing either the PV panel array's output voltage or output current and determining whether this increases or decreases the output power.

In an embodiment of a power maximization method, a number (N_{ON} defined above) of PCMs 210₁, 210₂, . . . 210_{N} operate in the efficient power mode and the remainder PCM converts the remainder power and operates an MPPT algorithm in the power maximization mode. All other PCMs 210₁, 210₂, . . . 210_{N} operate in standby mode. In an embodiment, MPC mode control module 240 determines which PCMs 210₁, 210₂, . . . 210_{N} operate in the efficient power mode, power maximization mode, and standby mode.

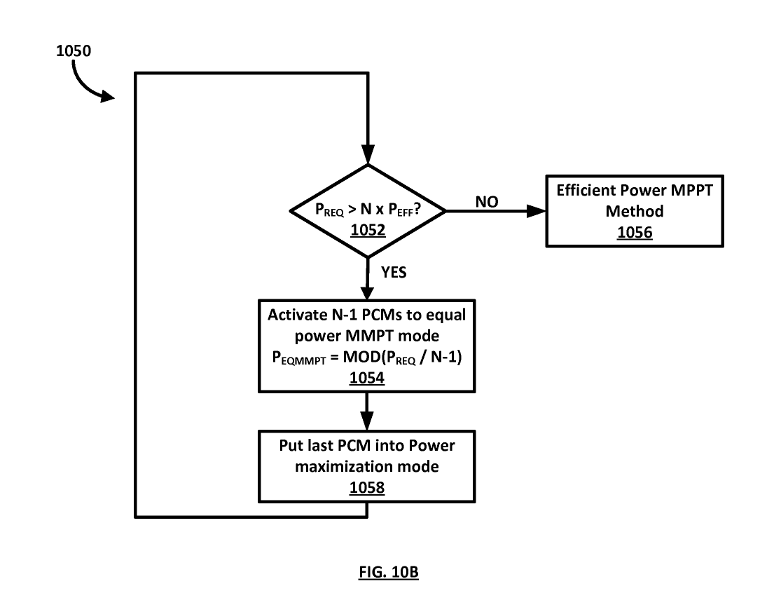

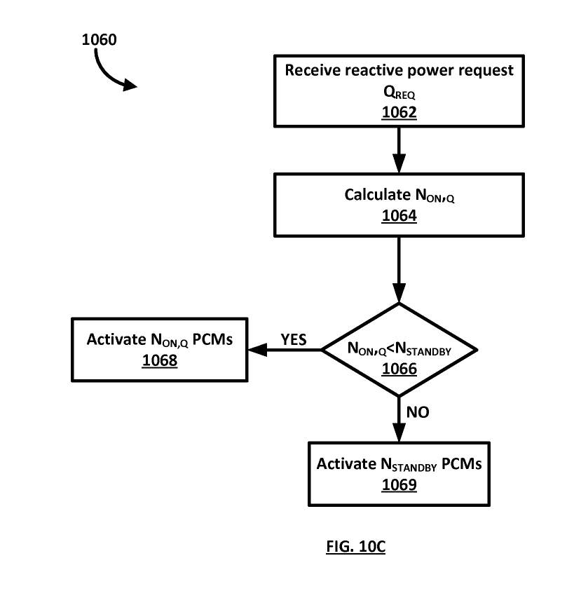

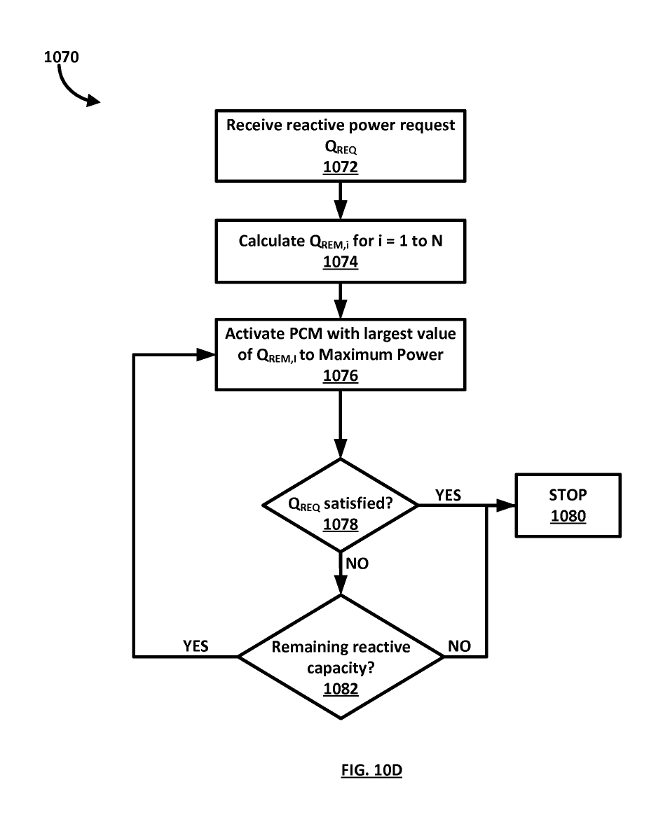

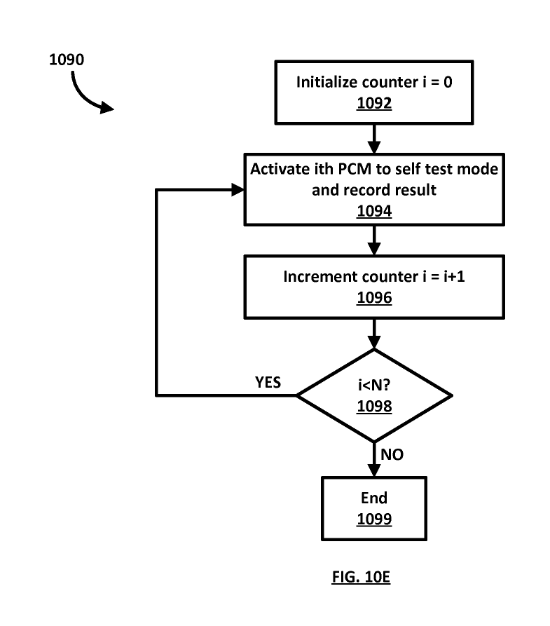

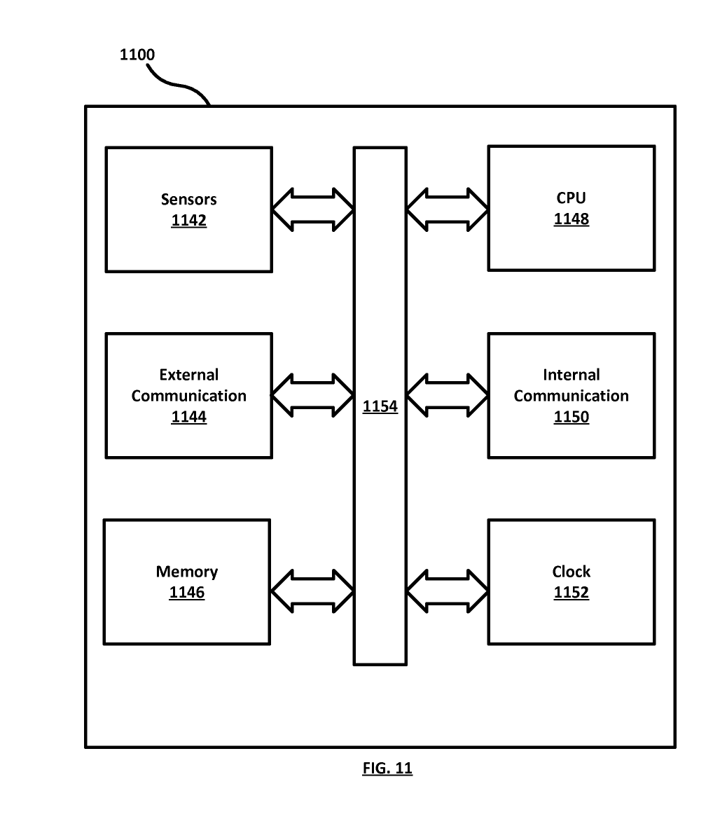

FIG. 10A, with reference to FIGS. 1 through 9B, is a flowchart of a power maximization method. In method 1000 the number (N_{ON}) of PCMs operating in efficient power mode is initialized to zero at step 1002. At step 1004, N_{ON} PCMs are activated to efficient power mode. At step 1006, the remainder PCM is activated to convert the remaining power. At step 1008 it is determined if the power of the remainder PCM is below a lower limit (L_{MIN}). If it is below L_{MIN}, then the number of PCMs operating in efficient power mode (N_{ON}) is decremented at step 1012. If it is not below L_{MIN}, then it is determined at 1010 if the power of remainder PCM is above an upper limit L_{MAX}. If it is above L_{MAX}, then the number of PCMs operating in efficient power mode (N_{ON}) is incremented at step 1014. If it is not above the upper limit L_{MAX}, then the remainder PCM is operated in power maximization mode and operates an MPPT algorithm to maintain the PV panel array at its MPP at step 1016. In one selected mode of operation, L_{MIN} is 5% of P_{EFF} and L_{MAX} is 110% of P_{EFF}.

Equal Power MPPT Method

In some embodiments, the maximum efficiency P_{EFF} of the PCMs could be sufficiently smaller than their maximum power conversion capacity (P_{MAX}) such that even with all PCMs in an MPC operating at P_{EFF} the power output of the PV array is larger than the maximum efficient power of the MPC and the MPC still has significant additional power conversion capacity available. In this case, the MPC could be operated in an “equal power MPPT” method. In this method, N−1 of the PCMs are all operated in an “equal power MPPT” mode. In the equal power MPPT mode, a PCM converts an amount of power (P_{EQMPPT}), where P_{EQMPPT}=MOD(P_{REQ}/N−1). The remaining PCM is operated in power maximization mode and converts the remainder power and operates the MPPT algorithm. FIG. 10B, with reference to FIGS. 1 through 10A, is a flowchart of an equal power MPPT method 1050. At step 1052, it is determined if the required power (P_{REQ}) exceeds the maximum efficient power of the MPC (the power that could be converted by all “N” PCMs operating at P_{EFF}). If P_{REQ} exceeds the maximum efficient power, then “N−1” PCMs are put into equal power MPPT mode and activated to each convert an amount of power P_{EQMPPT} at step 1054. At step 1058 the remaining PCM is put into power maximization mode. If P_{REQ} does not exceed the maximum efficient power at step 1052, then the MPC executes the efficient power MPPT method at step 1056.

Reactive Power Method

In one embodiment, MPC 100, 200, 400, 500 uses its remaining power conversion capacity to meet a reactive power request by activating PCMs in standby to produce or consume reactive power. The remaining modular power conversion capacity of the MPC is the total power conversion capacity of all PCMs in standby mode. In this embodiment, PCMs 110, 210, 310, 410, 510 are capable of four quadrant operation and can operate in a “reactive power” mode. In the reactive power mode, a PCM 110, 210, 310, 410, 510 supplies or consumes only reactive power. In the various embodiments, MPC mode control modules 140, 240, 340, 440, 540 are responsible for selecting which PCMs 110, 210, 310, 410, 510 are in reactive power mode and the amount of reactive power assigned to individual PCMs 110, 210, 310, 410, 510.

FIG. 10C, with reference to FIGS. 1 to 10B, is a flowchart illustrating a reactive power method 1060. At step 1062, mode control module 140, 240, 340, 440, 540 receives a request for an amount of reactive power Q_{REQ}. At step 1064, the number (N_{ON,Q}) of PCMs required to meet the reactive power request is determined. N_{ON,Q} is given by the formula:

$${N}_{ON , Q} = MOD ( \frac{{Q}_{REQ}}{{Q}_{MA X}} )$$

where Q_{MAX} is the maximum reactive power capacity of a PCM. At step 1066, it is determined if the number of PCMs required to meet the reactive power request is less than the number of PCMs currently in standby mode (N_{STANDBY}). If it is less than N_{STANDBY}, then N_{ON,Q} PCMs are activated at step 1068 to reactive power mode to each produce an amount of reactive power Q_{MAX}. If the number of PCMs required to meet the reactive power request is not less than the number of PCMs in standby mode, then N_{STANDBY} PCMs are activated at step 1069 to each produce an amount of reactive power Q_{MAX}.

Complex Power Method

In one embodiment, MPC 100, 200, 400, 500 produces complex power. Complex power is a combination of real and reactive power and is characterized by a power factor (PF) which is the ratio of real power to the apparent power. In this embodiment, PCMs 110, 210, 310, 410, 510 are capable of four quadrant operation and could operate in a “complex power” mode. In complex power mode, a PCM produces complex power. In one embodiment, MPC mode control module 140, 240, 340, 440, 540 determines which PCMs 110, 210, 310, 410, 510 are in complex power mode and the power factor of each individual PCM 110, 210, 310, 410, 510.

FIG. 10D, with reference to FIGS. 1 to 10C, is a flowchart illustrating a complex power method 1070. At step 1072, mode control module 140, 240, 340, 440, 540 receives a request for an amount of reactive power Q_{REQ}. At step 1074, the remaining reactive power capacity for all “N” PCMs in the MPC is calculated. The remaining reactive power capacity of the i-th PCM (Q_{REM,i}) is determined by the formula:

Q_{REM,i}=\sqrt{P_{MAX}²−Pᵢ²}

where P_{MAX} is the maximum power capacity of a PCM and Pᵢ is the amount of power being converted by the i-th PCM. At step 1076, the PCM with the largest value of remaining reactive power is activated to its maximum power capacity by controlling it to produce its remaining reactive power Q_{REM,i} in addition to its real power (Pᵢ). At step 1078, it is determined if the reactive power request has been satisfied by the MPC. If the request is satisfied the process terminates at step 1080. If the request has not been satisfied, it is determined at step 1082 whether the MPC has remaining reactive power capacity. If “NO” at step 1082, then the process terminates at step 1080. If “YES” at step 1082, then the PCM with the next largest value of Q_{REM,i} is activated at step 1076.

Self-Test

In one embodiment, MPC 100, 200, 400, 500 performs a self-test of its functions. In this embodiment, PCMs 110, 210, 310, 410, 510 could operate in a “self-test” mode. In the self-test mode, individual PCMs 110, 210, 310, 410, 510 could perform a test of their functional status and communicate a test result. Their functional status could be their ability to operate in efficient power mode, variable power mode, equal power mode, power maximization mode, equal power MPPT mode, reactive power mode, complex power mode, or other operating modes. A test result could be a pass/fail condition.

FIG. 10E, with reference to FIGS. 1 through 10D, is a flow diagram of a self-test method 1090. Counter “i” is initialized at step 1092. The i-th PCM is put into test mode at step 1094 and the result of the self-test is recorded. Counter “i” is incremented at step 1096. If the counter value is less N (than the number of PCMs in the MPC) at step 1098, then the next PCM is put into self-test at step 1094. If the counter is not less than N, then the method stops at step 1099. In one embodiment MPC mode control module 140, 240, 340, 440, 540 directs PCMs 110, 210, 310, 410, 510 to enter the self-test mode and maintains a record of the PCM test results.

Control Bus

Control bus 120, 220, 320, 420, 520 in MPC 100, 200, 300, 400, 500 could be serial or parallel and could carry data and/or instructions. For example, MPC mode control module 140, 240, 340, 440, 540 could issue commands to PCMs 110, 210, 310, 410, 510 and PCMs 110, 210, 310, 410, 510 could send measurement data to MPC mode control module 140, 240, 340, 440, 540 over control bus 120, 220, 320, 420, 520. Control bus 120, 220, 320, 420, 520 could use one of a number of common communication protocols including inter-integrated circuit (I2C), serial peripheral interface (SPI) bus. Control bus 120, 220, 320, 420, 520 could also be a point-to-point bus with dedicated connections between MPC mode control module 140, 240, 340, 440, 540 and each PCM 110, 210, 310, 410, 510.

MPC Mode Control Module

In one embodiment, MPC mode control module 140, 240, 340, 440, 540 controls the operating modes of PCMs 110, 210, 310, 410, 510.

FIG. 11, with reference to FIGS. 1 through 10E, is a block diagram of one embodiment of an MPC mode control module. MPC mode control module 1100 comprises sensors 1142, external communication interface 1144, memory 1146, CPU 1148, internal communication interface 1150, clock 1152, and internal bus 1154. MPC mode control module 1100 could receive power requests from a central grid controller through external communication interface 1144. In one embodiment, these are reactive power requests. Memory 1146 could store firmware or instructions for CPU 1148 and operating data for PCMs 110, 210, 310, 410, 510. Operating data could include the results of PCM self-test operations or hours of operation in the various operating modes of PCMs 110, 210, 310, 410, 510. MPC mode control module 1100 could be incorporated into one or several of PCMs 110, 210, 310, 410, 510. Such “master” PCMs could save rack space and could increase the reliability of the MPC.

PCM

FIG. 12, with reference to FIGS. 1 through 11, is a block diagram of an example PCM. PCM 1200 is a switch mode power converter and comprises switches 1202, switch drivers 1204, PCM controller 1206, communication interface 1208, passive elements 1210, and sensors 1212. Switches 1202 control the flow of power through passive components 1210 and could be, for example, power MOSFETS, IGBTs or thyristors. Passive components 1210 could include inductors, capacitors or transformers. A variety of known converter topologies might be used to configure switches 1202 and passive elements 1210 to implement various converter functions. Switch control signals for the opening and closing of switches 1202 are generated by PCM controller 1206 and sent to switch drivers 1204. Switch drivers 1204 receive the switch control signals and generate appropriately buffered and level shifted versions signals to apply to switches 1202. Sensors 1212 sense operational parameters such as currents, voltages or power and report them to controller 1208. Controller communication interface 1208 provides communication between controller 1208 and other MPC modules.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A method for converting electrical power, said method comprising:
providing a modular power converter comprising a mode control module and a plurality of autonomously operating power conversion modules operatively connected to a first power bus;
selecting, by said mode control module, individual modes of operation for said plurality of power conversion modules to meet a power conversion requirement;
receiving electrical power of a first power type from said first power bus by at least one of said power conversion modules; and
converting the received electrical power into electrical power of a second power type by said at least one power conversion module.

2. The method of claim 1, wherein said plurality of power conversion modules comprise substantially equal volts-amperes-reactive conversion capacities, and wherein the selecting of individual modes of operation comprises selecting said power conversion modules to operate in either a standby mode or one of an inductive or a capacitive mode so that reactive power is either absorbed or supplied to said first power bus.

3. The method of claim 2, wherein said power conversion modules operating in one of the inductive or capacitive mode all convert substantially the same volts-amperes-reactive (VAr) amounts.

4. The method of claim 1, further comprising supplying the power of said second power type to a second power bus that is operatively connected to each of said plurality of autonomously operating power conversion modules.

5. The method of claim 4, wherein the selecting of individual modes of operation comprises selecting said power conversion modules to operate in different power modes selected based on a substantially maximum power efficiency.

6. The method of claim 1, wherein said individual modes of operation comprise any of an efficient power mode, a variable power mode, and a standby mode.

7. The method of claim 3, wherein the selecting of individual modes of operation comprises selecting one of said power conversion modules to operate in a variable power mode and selecting all other power conversion modules to operate in either an efficient power mode or a standby mode during power conversion.

8. The method of claim 1, wherein the selecting of individual modes of operation comprises selecting said plurality of power conversion modules to all operate in an equal power mode when said power conversion requirement is greater than a maximum efficient power of said modular power converter.

9. The method of claim 1, wherein the selecting of individual modes of operation comprises selecting at least one of said power conversion modules to operate in a power maximization mode and selecting all other power conversion modules to operate in an efficient power mode or standby mode.

10. The method of claim 9, wherein in said power maximization mode, said method further comprises said at least one of said power conversion modules operating a maximum power point tracking process that maximizes a power production of a photovoltaic panel array operatively connected to said second power bus.

11. The method of claim 1, wherein the selecting of individual modes of operation comprises selecting at least one of said power conversion modules to operate in a power maximization mode and all other power conversion modules to operate in equal power maximum power point tracking mode when said power conversion requirement is greater than a maximum efficient power of said modular power converter.

12. The method of claim 1, wherein the selecting of individual modes of operation comprises selecting at least one of said power conversion modules to operate in a reactive power mode.

13. The method of claim 12, wherein the selecting of individual modes of operation comprises selecting a number of power conversion modules to operate in any of said reactive power mode and a complex power mode to meet a reactive power requirement up to a remaining power conversion capacity of said modular power converter.

14. The method of claim 13, wherein the power conversion modules selected for said complex power mode produce reactive power to meet a reactive power requirement up to a remaining reactive power of the power conversion module and all remaining power conversion modules operate in a standby mode or produce only real power.

15. The method of claim 4, further comprising supplying the power of said second type on said second power bus after conversion from the power of said first type on said first power bus or supplying the power of said first type on said first power bus after conversion from the power of said second type on said second power bus.

16. The method of claim 1, wherein said first power bus comprises a multiphase bus and the steps of selecting of individual modes of operation and converting the received power into said electrical power of said second type by said at least one power conversion module comprises providing differing amounts of electrical power to each phase of said multiphase bus to maintain root mean square (RMS) voltage values of the different phases substantially equal.

17. A modular power converter system comprising:
a first power bus;
a plurality of autonomously functioning power conversion modules operatively connected to said first power bus; and
a mode control module that selects power conversion modes for said plurality of autonomously functioning power conversion modules,
wherein said plurality of autonomously functioning power conversion modules convert electrical power on said first power bus having power of a first power type into power of a second power type depending on power conversion requirements.

18. The system of claim 17, further comprising a second power bus operatively connected to each of said plurality of autonomously functioning power conversion modules, wherein said plurality of autonomously functioning power conversion modules function to convert power from said first power bus comprising a first power type into power comprising a second power type for output onto said second power bus.

19. The system of claim 17, further comprising:
a second power bus operatively connected to each of said plurality of autonomously functioning power conversion modules,
wherein said plurality of autonomously functioning power conversion modules:
convert power from said first power bus comprising said first power type into power comprising said second power type for output onto said second power bus, and
convert power from said second power bus comprising a second power type into power comprising said first power type for output onto said first power bus.

20. The system of claim 19, further comprising:
a switching module to operably engage said modular power converter to a first external electrical power source; and
a plurality of electrical connections operatively connected to said second power bus to operably connect to a second external electrical power source,
wherein said modular power converter bidirectionally converts power between said first power bus and said second power bus, and
wherein said switching module engages or disengages said first external electrical power source from said modular power converter.

21. The system of claim 20, wherein said first external electrical power source comprises an AC grid, and wherein said second external electrical power source comprises a DC storage device.

22. The system of claim 21, wherein said switching module disconnects said AC grid from said modular power converter during a grid power outage.

23. The system of claim 17, further comprising a power shelf to which said plurality of autonomously functioning power conversion modules and said mode control module are removably mounted thereto.

24. The system of claim 23, further comprising:
a communication bus;
a plurality of first socket connections in said power shelf that provide electrical connection of said plurality of autonomously functioning power conversion modules to said first power bus; and
a plurality of second socket connections that operatively connect said plurality of autonomously functioning power conversion modules and said mode control module to said communication bus.

25. The system of claim 23, wherein said power shelf comprises a rack comprising at least one slot that receives said mode control module.

26. The system of claim 23, wherein said autonomously functioning power conversion modules and said mode control module are removably attached and detached to said power shelf without powering down said modular power converter system.

27. A modular power converter comprising:
a communication bus;
a first DC power bus;
an AC power bus;
a second DC power bus;
a plurality of autonomously functioning power conversion modules of a first type operatively connected to said communication bus, each operatively connected to said first DC power bus, and each operatively connected to said second DC power bus;
a plurality of autonomously functioning power conversion modules of a second type operatively connected to said communication bus, each operatively connected to said first DC power bus, and each operatively connected to said AC power bus;
an electrical connection that operatively connects said first DC power bus to an external power source; and
a mode control module operatively connected to said communication bus, wherein said mode control module selects power conversion modes for said plurality of autonomously functioning power conversion modules,
wherein said modular power converter performs multiple power conversion functions depending on load and power conversion requirements.

28. The modular power converter of claim 27, further comprising an electrical connection that operatively connects said second DC power bus to a power generator.
